(19) United States
(12) Patent Application Publication
(10) Pub. No.: US 2018/0194128 A1
(43) Pub. Date: Jul. 12, 2018

(54) ENHANCED MASK FOR REDUCING LIGHT SCATTERING

(71) Applicant: Ulano International, Inc., Brooklyn, NY (US)

(72) Inventors: Mohammad J. Akhter, Brooklyn, NY (US); Yuliya Finkel, Rego Park, NY (US)

(21) Appl. No.: 15/401,282

(22) Filed: Jan. 9, 2017

(51) Int. Cl. B41F 15/00; C09D 139/06; C09D 133/00; C09D 175/04; C09D 129/04; B41C 1/14

(52) U.S. Cl. CPC B41F 15/00; C09D 139/06; B41C 1/14; C09D 175/04; C09D 129/04; C09D 133/00

(57) ABSTRACT

The present invention is directed toward the reduction of light scattering for “masks” that are used also to convey information by transmission onto light-sensitive materials used for screen printing (stencils), pad printing (cliches), gravure (cylinders), flexography (plates), and other printing processes.

### BACKGROUND OF THE INVENTION

The present invention is directed toward the reduction of light scattering for “masks” that are used also to convey information by transmission onto light-sensitive materials used for screen printing (stencils), pad printing (cliches), gravure (cylinders), flexography (plates), and other printing processes.

There are varying needs in the ever-expanding realm of screen-printing. Regardless of how technical or perhaps how simple the need, when it comes to the use of any one company's film or emulsion products, imaging and exposure are the primary and most important factors. In this field of applications and technical service the most important factors are how well the stencil is prepared or what is used as a positive and how thoroughly the exposure is carried out.

Currently, in order to create stencils, plates, pads, etc., a “mask” is created to convey information by transmission (unless computer-to-screen direct imaging is used; or direct printing such as inkjet or 3D). “Masks” are usually created on transparent materials. These tend to scatter light by diffraction as it passes through the body of the “mask.” Additional light scattering is also possible if the light source does not provide collimated lighting, in which case light approaches the mask and then the material being exposed to light from different incident angles. Some processes include separate Fresnel lenses, or use other means to reduce light scattering.

In screen printing a negative of a print design, known as a stencil, is produced on a mesh or screen in those areas of the screen where printing is not applied, referred to as the stencil areas, and are covered with a material impervious to the ink to be used for the printing. Typically the screen mesh is a polyamide, polyester or stainless steel mesh, stretched over a wooden or metal frame. The blocked areas, such as by a mask, will hold back screen printing ink when a squeegee blade or other implement is used to force ink through the mesh onto the surface of the article to be printed.

Digital printing is increasingly used over conventional printing methods for many applications such as for the labels and in the graphic arts. Digital printing methods (such as ink-jet printing) have the advantage that no printing plates need be prepared in advance and thus the substrate mask can be immediately printed with the data sent to the printer. Digital printing is especially suitable for low volume print runs or for variable information printing where the information printed to each article can be different. This is useful for example where products need to be individually traced, or to customize products for example for different seasons, for competitions; in different languages, or for test products. Costs can be reduced as less pre-printed material needs to be stored. Ink-jet printing (both piezo and thermal ink jet) is the form of digital printing which is most widely used for example in the label and graphic arts fields.

Inkjet printers can be used as a replacement for a high-priced image setters and low quality laser printers. Certain ink jet printers use a room temperature mechanical, piezo technology of precise electrical pulses that cause the ink reservoir well in the head to compress, projecting ink through the nozzle. Programmers can also control the exact placement, size, and shape of each dot then shape with the millions of ink droplets they eject in each square inch. Screen or mask printing often requires a one color printer and programmers can increase ink deposit to make the ink opaque enough to block UV light.

To make screen printing positives with an inkjet printer, you must have an absorbent coating on clear film. For example, Ulano Pigment Inkjet Films are designed to make such positives. Dye inks are 100% liquid and can be absorbed by a swellable coating like the gelatin in indirect stencil films. Pigment inks require a micro porous coating with microscopic cavities that can absorb the resin coated pigment particles with natural capillary action.

For many applications of printable polymer films (such as labels or graphic art displays) it is important to have a wide choice in the film that may be selected so that the substrate performance and appearance characteristics can be chosen to match to the particular application. Each polymer film exhibits different performance and appearance properties and common label films such as: acetate; polyethylene (PE); polystyrene (PS); polypropylene (PP); vinyl (PVC) and polyester (PET), are each more appropriately selected to particular end uses.

The pigmented inkjet film of the invention is compatible with dye or pigment inks. Some of the criteria that an ideal ink-jet receptive substrate will possess include some or all of the following, depending on the particular application (e.g. for a “no-label” look transparency is important rather than whiteness or opacity). A suitable ink-jet printable substrate will have good optical properties such as brightness, whiteness, gloss, opacity and/or colour gamut to give high-quality printed images. The substrate should be compatible with components in the ink to ensure that the final ink image has sufficient fastness and low tendency to fade for example when exposed to UV light. The absorbency of the film surface is important. Ink jet printing places special demands on the substrate which is printed with a large amount of liquid, and yet is expected to dry quickly without changing size or shape. Although paper fibres absorb liquid well, they can swell and deform, resulting in surface imperfections and such moisture-induced undulations have a detrimental effect on image quality. Paper is also unsuitable for many applications as described herein. A suitable substrate will be durable and will maintain its structure for the time of the print and thus is determined by its dimensional stability, tear resistance, thermal stability, and water and light resistance. The ink jet printable coating and film are both relevant components when determining the durability of the media. Thus to produce a good image by an ink jet printer, the ink receiving surface should be dimensionally and thermally stable, i.e. not tear, stretch or deform, should be smooth and waterproof, maintain its shape and be resistant to many chemicals and should not swell or shrink with moisture or humidity.

In the prior art the only possible way to reduce effects of poorly collimated light was to use yellow mesh instead of white to reduce light scattering and image distortion.

This invention adds diffraction-reduction either by incorporating its properties into the body of the “mask” or by including it in the imageable layer.

The current invention allows for reducing light-scattering and, therefore, improved image acutance and resolution of the mask, which in turn improves the quality of the printed image.

Therefore it is an object of the present invention to overcome some of the problems described herein to provide a film substrate which is printable by a digital printing method, preferably ink-jet printing, for example by providing a coating suitable for use with a wide variety of common film types to improve their reception to ink-jettable inks.

With the invention of highly transparent positives or better yet inventive yellow positives, where the yellow tint is introduced in the base material or in the special coating to the base material or included as in examples above into the formulation of ink receptive layer, we will be providing the users capability of varying exposure parameters without compromising the imaging, allowing for better, stronger, more durable stencils to achieve longer printing runs, without use of special hardeners or more specialized and more expensive stencil products.

We are enabling users to eliminate the detrimental variables caused by extensive light scattering and the mistakes of overexposing. If the light scattering can be controlled/diminished during the preparation of the artwork, there is a reduced expense due to yellow mesh being no longer needed.

Styryl Basolium Quaternary photopolymers (SBQ photopolymers) films and emulsions are designed to be fast, and basically the only downside is controlling an emulsion designed to expose so rapidly. The films of the invention such as, e.g., the inventive diffraction reducing yellow, reduces light scattering and improves working latitude of a product. The films of the invention have the potential for tremendously reducing trivial errors of overexposing. An end-user, especially with a very good UV light source, utilizing fast exposing emulsions will be more worry free of targeting correct exposure and will be able to take advantage of increased durability due to increase exposure. Diazo emulsion and films are designed with longer exposure and having more forgiving latitude generally can still benefit from the inventive films, primarily benefiting from not having the need of different color mesh.

Concluding, the effectiveness of the films of the invention, such as yellow masking with a mask comprising a diffraction reducing agent, has noticeably tremendous advantages. The inventive clear mask has keen advantages when compared to current standard SBQ emulsions, more so than the film.

All of the previously existing films have some disadvantages when being printed with ink-jettable inks. The present invention relates to improved substrates for use in digital printing methods such as plastic films having thereon a receptive coating printable with ink-jettable inks, the film being useful for example in label and graphic arts applications.

All references cited herein are incorporated herein by reference in their entireties.

### BRIEF SUMMARY OF THE INVENTION

The invention provides a light transmissive film having an ink receptive coating comprising: a support layer, wherein the support layer is coated with an ink receiving layer, wherein said ink receiving layer comprises: at least one diffraction reducing agent present at a concentration of about 0.001%-3.0%; at least one absorbing polymer present at a concentration of about 0.10-50% by weight; at least one film-forming polymeric binder present at a concentration of about 0-30% by weight; at least one film-forming polymeric secondary binder present at a concentration of about 0-30% by weight; at least one filler dispersion present at a concentration of about 0.10-25% by weight; at least one coagulating agent present at a concentration of about 0.2-15% by weight; at least one wetting agent present at a concentration of about 0.1-1% by weight. The invention provides a light transmissive film wherein the support layer is selected from the group consisting of polyolefin, polyester, polyamide, acrylic, polyurethane, polyethylene, polypropylene, polystyrene, polyethylene terephthalate, polyethylene naphthalate, triacetylcellulose, polyvinyl chloride, polyvinylidene chloride, polyimide, polycarbonate, cellophane, polynylon, and combinations thereof. The invention provides a light transmissive film wherein the at least one diffraction reducing agent is selected from the group consisting of Yellow Dye #5, Tartrazine, Pigment Yellow 14, Pigment Yellow 83, Pigment Yellow 155, Pigment Yellow 74, and combinations thereof. The invention provides a light transmissive film wherein the at least one absorbing polymer is selected from the group consisting of polyvinylpyrrolidone, cross-linked PVP, polyvinyl-alcohol, modified celluloses, methylcellulose, hydroxypropylmethylcellulose and hydroxyethyl-methylcellulose, ethylcellulose, ethylhydroxyethyl cellulose and hydroxybutyl cellulose, polyacrylamides, modified polyvinyl pyrrolidones, polyvinyl alcohol, modified polyvinyl alcohols methacrylamide; alkyltertiaryaminoalkylacryates and methacrylates; vinylpyridines such as 2-vinyl and 4-vinyl pyridines; preferably N-vinyl-2-pyrrolidone; acrylamide, methacrylamide and their N-monoalkyl and N,N-dialkyl derivatives thereof; hydroxyalkyl acrylate, methacrylate, and combinations thereof. The invention provides a light transmissive film wherein the at least one film-forming polymeric binder is selected from the group consisting of acrylic, cationic polymer dispersions, a cationic styrene-acrylic latex polymer, vinyl chloride-vinyl acetate copolymers, vinyl chloride-vinyl acetate-vinyl alcohol copolymers, vinyl chloride-vinyl acetate-maleic acid polymers, vinyl chloride-vinylidene chloride copolymers, vinyl chloride-acrylonitrile copolymers, acrylic ester-acrylonitrile copolymers, acrylic estervinylidene chloride copolymers, methacrylic estervinylidene chloride copolymers, methacrylic esterstylene copolymers, thermoplastic polyurethane resins, phenoxy resins, polyvinyl alcohol, polyvinyl fluoride, vinylidene, chloride-acrylonitrile copolymers, butadieneacrylonitrile copolymers, acrylonitrile-butadieneacrylic acid copolymers, acrylonitrile-butadienemethacrylic acid copolymers, polyvinyl butyral, polyvinyl acetal, cellulose derivatives, styrenebutadiene copolymers, polyester resins, phenolic resins, epoxy resins, thermosetting polyurethane resins, urea resins, melamine resins, alkyl resins, urea-formaldehyde resins, cellulose acetate, cellulose diacetate, cellulose triacetate, cellulose acetate butyrate, cellulose acetate propionate, and combinations thereof. The invention provides a light transmissive film wherein the at least one film-forming polymeric secondary binder is selected from the group consisting of acrylic, cationic polymer dispersions, a cationic styrene-acrylic latex polymer, vinyl chloride-vinyl acetate copolymers, vinyl chloride-vinyl acetate-vinyl alcohol copolymers, vinyl chloride-vinyl acetate-maleic acid polymers, vinyl chloride-vinylidene chloride copolymers, vinyl chloride-acrylonitrile copolymers, acrylic ester-acrylonitrile copolymers, acrylic estervinylidene chloride copolymers, methacrylic estervinylidene chloride copolymers, methacrylic esterstylene copolymers, thermoplastic polyurethane resins, phenoxy resins, polyvinyl alcohol, polyvinyl fluoride, vinylidene, chloride-acrylonitrile copolymers, butadieneacrylonitrile copolymers, acrylonitrile-butadieneacrylic acid copolymers, acrylonitrile-butadienemethacrylic acid copolymers, polyvinyl butyral, polyvinyl acetal, cellulose derivatives, styrenebutadiene copolymers, polyester resins, phenolic resins, epoxy resins, thermosetting polyurethane resins, urea resins, melamine resins, alkyl resins, urea-formaldehyde resins, cellulose acetate, cellulose diacetate, cellulose triacetate, cellulose acetate butyrate, cellulose acetate propionate, and combinations thereof. The invention provides a light transmissive film wherein the at least one filler dispersion is selected from the group consisting of Silica, colloidal silica, alumina or alumina hydrate, colloidal alumina, a surface-processed cation colloidal silica, aluminum silicate, magnesium silicate, magnesium carbonate, titanium dioxide, zinc oxide, calcium carbonate, kaoline, talc, clay, calcium sulfate, barrium sulfate, zinc sulfate, zinc carbonate, satin white, diatomaceous earth, synthetic amorphous silica, aluminum hydroxide, lithopone, zeolite, magnesium hydroxide, synthetic mica, polystyrene, polymethacrylate, polymethyl-methacrylate, elastomers, ethylene-vinyl acetate copolymers, polyesters, polyester-copolymers, polyacrylates, polyvinylethers, polyamides, polyolefines, polysilicones, guanamine resins, polytetrafluoroethylene, elastomeric styrene-butadiene rubber (SBR), elastomeric butadiene-acrylonitrile rubber (NBR), urea resins, urea-formalin resins, and combinations thereof. The invention provides a light transmissive film wherein the at least one coagulating agent is polymerized diallyldimethylammonium chloride (polyDADMAC).

The invention provides a light transmissive film wherein the at least one wetting agent is selected from the group consisting of ethoxylated surfactants, polytetrafluoroalkylene surfactants, ethoxylated surfactants, Polytetrafluoroalkylene surfactants, polyethylene oxide-b-poly(tetrafluoroethylene)polymers, 2-(perfluoroalkyl)ethyl stearate, anionic lithium carboxylate fluorosurfactant, anionic phosphate fluorosurfactant, anionic phosphate surfactant, amphoteric quaternary ammonium-acetate fluorosurfactant, fluoroaliphatic polymeric esters, their derivatives, ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether, and combinations thereof.

The invention provides a method of making a light transmissive film having an ink receptive coating, the method comprising the steps of: providing a support layer, coating the support layer with an ink receiving layer, wherein said ink receiving layer comprises: at least one diffraction reducing agent present at a concentration of about 0.001%-3.0%; at least one absorbing polymer present at a concentration of about 0.10-50% by weight; at least one film-forming polymeric binder present at a concentration of about 0-30% by weight; at least one film-forming polymeric secondary binder present at a concentration of about 0-30% by weight; at least one filler dispersion present at a concentration of about 0.10-25% by weight; at least one coagulating agent present at a concentration of about 0.2-15% by weight; at least one wetting agent present at a concentration of about 0.1-1% by weight, thereby making a light transmissive film. The invention provides a method of making a mask screen printing positive, the method comprising the steps of: i) providing a light transmissive film having an ink receptive coating comprising: a support layer, wherein the support layer is coated with an ink receiving layer, wherein said ink receiving layer comprises: at least one diffraction reducing agent present at a concentration of about 0.001%-3.0%; at least one absorbing polymer present at a concentration of about 0.10-50% by weight; at least one film-forming polymeric binder present at a concentration of about 0-30% by weight; at least one film-forming polymeric secondary binder present at a concentration of about 0-30% by weight; at least one filler dispersion present at a concentration of about 0.10-25% by weight; at least one coagulating agent present at a concentration of about 0.2-15% by weight; at least one wetting agent present at a concentration of about 0.1-1% by weight, ii) applying an image to the light transmissive film.

The invention provides a method of screen printing, the method comprising the steps of: i) providing a light transmissive film having an ink receptive coating comprising: a support layer, wherein the support layer is coated with an ink receiving layer, wherein said ink receiving layer comprises: at least one diffraction reducing agent present at a concentration of about 0.001%-3.0%; at least one absorbing polymer present at a concentration of about 0.10-50% by weight; at least one film-forming polymeric binder present at a concentration of about 0-30% by weight; at least one film-forming polymeric secondary binder present at a concentration of about 0-30% by weight; at least one filler dispersion present at a concentration of about 0.10-25% by weight; at least one coagulating agent present at a concentration of about 0.2-15% by weight; at least one wetting agent present at a concentration of about 0.1-1% by weight, ii) applying an image to the light transmissive film, thereby forming a mask, iii) applying the mask to a light-sensitive material, iv) exposing the mask and light sensitive material to a radiation source, forming a film master image, v) removing the mask, vi) removing the uncured light sensitive material, thereby forming a stencil.

The invention provides a light transmissive film having an ink receptive coating comprising: a support layer, wherein the support layer is coated with an ink receiving layer, wherein said ink receiving layer comprises: at least one diffraction reducing agent present at a concentration of about 0.001%-3.0%; at least one polyvinyl alcohol present at a concentration of about 30-60% by weight; at least one film forming polymeric binder present at a concentration of about 30-60% by weight; at least one filler dispersion present at a concentration of about 10-30% by weight; at least one wetting agent present at a concentration of about 0.1-1% by weight. The invention provides a light transmissive film wherein the at least one film-forming polymeric binder is selected from the group consisting of binder is selected from the group consisting of acrylic, cationic polymer dispersions, a cationic styrene-acrylic latex polymer, vinyl chloride-vinyl acetate copolymers, vinyl chloride-vinyl acetate-vinyl alcohol copolymers, vinyl chloride-vinyl acetate-maleic acid polymers, vinyl chloride-vinylidene chloride copolymers, vinyl chloride-acrylonitrile copolymers, acrylic ester-acrylonitrile copolymers, acrylic estervinylidene chloride copolymers, methacrylic estervinylidene chloride copolymers, methacrylic esterstylene copolymers, thermoplastic polyurethane resins, phenoxy resins, polyvinyl alcohol, polyvinyl fluoride, vinylidene, chloride-acrylonitrile copolymers, butadieneacrylonitrile copolymers, acrylonitrile-butadieneacrylic acid copolymers, acrylonitrile-butadienemethacrylic acid copolymers, polyvinyl butyral, polyvinyl acetal, cellulose derivatives, styrenebutadiene copolymers, polyester resins, phenolic resins, epoxy resins, thermosetting polyurethane resins, urea resins, melamine resins, alkyl resins, urea-formaldehyde resins, cellulose acetate, cellulose diacetate, cellulose triacetate, cellulose acetate butyrate, cellulose acetate propionate, and combinations thereof, and combinations thereof. The invention provides a light transmissive film wherein the support layer is selected from the group consisting of polyolefin, polyester, polyamide, acrylic, polyurethane, polyethylene, polypropylene, polystyrene, polyethylene terephthalate, polyethylene naphthalate, triacetylcellulose, polyvinyl chloride, polyvinylidene chloride, polyimide, polycarbonate, cellophane, polynylon, and combinations thereof. The invention provides a light transmissive film wherein the at least one diffraction reducing agent is selected from the group consisting of Yellow Dye #5, Tartrazine, Pigment Yellow 14, Pigment Yellow 83, Pigment Yellow 155, Pigment Yellow 74, and combinations thereof. The invention provides a light transmissive film wherein the at least one filler dispersion is selected from the group consisting of styrene acrylic emulsion polymer, styrene, acrylic, styrene/acrylics, vinyl/acetate, poly acrylics, methacrylates or combinations thereof, and combinations thereof. The invention provides a light transmissive film wherein the at least one wetting agent is selected from the group consisting of ethoxylated surfactants, polytetrafluoroalkylene surfactants, ethoxylated surfactants, Polytetrafluoroalkylene surfactants, polyethylene oxide-b-poly(tetrafluoroethylene)polymers, 2-(perfluoroalkyl)ethyl stearate, anionic lithium carboxylate fluorosurfactant, anionic phosphate fluorosurfactant, anionic phosphate surfactant, amphoteric quaternary ammonium-acetate fluorosurfactant, fluoroaliphatic polymeric esters, their derivatives, ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether, and combinations thereof.

The invention provides a method of making a light transmissive film having an ink receptive coating, the method comprising the steps of: providing a support layer, coating the support layer with an ink receiving layer, wherein said ink receiving layer comprises: at least one diffraction reducing agent present at a concentration of about 0.001%-3.0%; at least one polyvinyl alcohol present at a concentration of about 30-60% by weight; at least one film forming polymeric binder present at a concentration of about 30-60% by weight; at least one filler dispersion present at a concentration of about 10-30% by weight; at least one wetting agent present at a concentration of about 0.1-1% by weight, thereby making a light transmissive film.

The invention provides a method of making a mask screen printing positive, the method comprising the steps of: i) providing a light transmissive film having an ink receptive coating comprising: a support layer, wherein the support layer is coated with an ink receiving layer, wherein said ink receiving layer comprises: at least one diffraction reducing agent present at a concentration of about 0.001%-3.0%; at least one polyvinyl alcohol present at a concentration of about 30-60% by weight; at least one film forming polymeric binder present at a concentration of about 30-60% by weight; at least one filler dispersion present at a concentration of about 10-30% by weight; at least one wetting agent present at a concentration of about 0.1-1% by weight ii) applying an image to the light transmissive film. The invention provides a method of screen printing, the method comprising the steps of: i) providing a light transmissive film having an ink receptive coating comprising: a support layer, wherein the support layer is coated with an ink receiving layer, wherein said ink receiving layer comprises: at least one diffraction reducing agent present at a concentration of about 0.001%-3.0%; at least one polyvinyl alcohol present at a concentration of about 30-60% by weight; at least one film forming polymeric binder present at a concentration of about 30-60% by weight; at least one filler dispersion present at a concentration of about 10-30% by weight; at least one wetting agent present at a concentration of about 0.1-1% by weight ii) applying an image to the light transmissive film, thereby forming a mask, iii) applying the mask to a light-sensitive material, iv) exposing the mask and light sensitive material to a radiation source, forming a film master image, v) removing the mask, vi) removing the uncured light sensitive material, thereby forming a stencil.

The invention provides a light transmissive film having an ink receptive coating comprising: a support layer, wherein the support layer is coated with an ink receiving layer, wherein said ink receiving layer comprises: at least one diffraction reducing agent present at a concentration of about 0.001%-3.0%; at least one crosslinked polyvinylpyrrolidone (PVP) present at a concentration of about 10-25%; at least one polyvinyl alcohol present at a concentration of about 10-255% by weight; at least one film forming polymeric binder present at a concentration of about 0-30% by weight; at least one wetting agent present at a concentration of about 0.1-1% by weight. The invention provides a light transmissive film wherein the support layer is selected from the group consisting of polyolefin, polyester, polyamide, acrylic, polyurethane, polyethylene, polypropylene, polystyrene, polyethylene terephthalate, polyethylene naphthalate, triacetylcellulose, polyvinyl chloride, polyvinylidene chloride, polyimide, polycarbonate, cellophane, polynylon, and combinations thereof. The invention provides a light transmissive film wherein the at least one diffraction reducing agent is selected from the group consisting of Yellow Dye #5, Tartrazine, Pigment Yellow 14, Pigment Yellow 83, Pigment Yellow 155, Pigment Yellow 74, and combinations thereof. The invention provides a light transmissive film wherein the at least one film-forming polymeric binder is selected from the group consisting of acrylic, cationic polymer dispersions, a cationic styrene-acrylic latex polymer, vinyl chloride-vinyl acetate copolymers, vinyl chloride-vinyl acetate-vinyl alcohol copolymers, vinyl chloride-vinyl acetate-maleic acid polymers, vinyl chloride-vinylidene chloride copolymers, vinyl chloride-acrylonitrile copolymers, acrylic ester-acrylonitrile copolymers, acrylic estervinylidene chloride copolymers, methacrylic estervinylidene chloride copolymers, methacrylic esterstylene copolymers, thermoplastic polyurethane resins, phenoxy resins, polyvinyl alcohol, polyvinyl fluoride, vinylidene, chloride-acrylonitrile copolymers, butadieneacrylonitrile copolymers, acrylonitrile-butadieneacrylic acid copolymers, acrylonitrile-butadienemethacrylic acid copolymers, polyvinyl butyral, polyvinyl acetal, cellulose derivatives, styrenebutadiene copolymers, polyester resins, phenolic resins, epoxy resins, thermosetting polyurethane resins, urea resins, melamine resins, alkyl resins, urea-formaldehyde resins, cellulose acetate, cellulose diacetate, cellulose triacetate, cellulose acetate butyrate, cellulose acetate propionate, and combinations thereof. The invention provides a light transmissive film wherein the at least one wetting agent is selected from the group consisting of ethoxylated surfactants, polytetrafluoroalkylene surfactants, ethoxylated surfactants, Polytetrafluoroalkylene surfactants, polyethylene oxide-b-poly(tetrafluoroethylene)polymers, 2-(perfluoroalkyl)ethyl stearate, anionic lithium carboxylate fluorosurfactant, anionic phosphate fluorosurfactant, anionic phosphate surfactant, amphoteric quaternary ammonium-acetate fluorosurfactant, fluoroaliphatic polymeric esters, their derivatives, ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether, and combinations thereof.

The invention provides a method of making a light transmissive film having an ink receptive coating, the steps comprising: providing a support layer, coating the support layer with an ink receiving layer, wherein said ink receiving layer comprises: at least one diffraction reducing agent present at a concentration of about 0.001%-3.0%; at least one crosslinked polyvinylpyrrolidone (PVP) present at a concentration of about 10-25%; at least one polyvinyl alcohol present at a concentration of about 10-255% by weight; at least one film forming polymeric binder present at a concentration of about 0-30% by weight; at least one wetting agent present at a concentration of about 0.1-1% by weight, thereby making a light transmissive film. The invention provides a method of making a mask screen printing positive, the method comprising the steps of: i) providing a light transmissive film having an ink receptive coating comprising: a support layer, wherein the support layer is coated with an ink receiving layer, wherein said ink receiving layer comprises: at least one diffraction reducing agent present at a concentration of about 0.001%-3.0%; at least one crosslinked polyvinylpyrrolidone (PVP) present at a concentration of about 10-25%; at least one polyvinyl alcohol present at a concentration of about 10-255% by weight; at least one film forming polymeric binder present at a concentration of about 0-30% by weight; at least one wetting agent present at a concentration of about 0.1-1% by weight ii) applying an image to the light transmissive film.

The invention provides a method of screen printing, the method comprising the steps of: i) providing a light transmissive film having an ink receptive coating comprising: a support layer, wherein the support layer is coated with an ink receiving layer, wherein said ink receiving layer comprises: at least one diffraction reducing agent present at a concentration of about 0.001%-3.0%; at least one crosslinked polyvinylpyrrolidone (PVP) present at a concentration of about 10-25%; at least one polyvinyl alcohol present at a concentration of about 10-255% by weight; at least one film forming polymeric binder present at a concentration of about 0-30% by weight; at least one wetting agent present at a concentration of about 0.1-1% by weight ii) applying an image to the light transmissive film, thereby forming a mask, iii) applying the mask to a light-sensitive material, iv) exposing the mask and light sensitive material to a radiation source, forming a film master image, v) removing the mask, vi) removing the uncured light sensitive material, thereby forming a stencil.

The invention provides a light transmissive film having an ink receptive coating comprising: a support layer, wherein the support layer is coated with an ink receiving layer, wherein said ink receiving layer comprises: at least one absorbing polymer present at a concentration of about 0.10-50% by weight; at least one film-forming polymeric binder present at a concentration of about 0-30% by weight; at least one film-forming polymeric secondary binder present at a concentration of about 0-30% by weight; at least one filler dispersion present at a concentration of about 0.10-25% by weight; at least one coagulating agent present at a concentration of about present at a concentration of about 0.2-15% by weight; at least one wetting agent present at a concentration of about 0.1-1% by weight. The invention provides a light transmissive film wherein the support layer is selected from the group consisting of polyolefin, polyester, polyamide, acrylic, polyurethane, polyethylene, polypropylene, polystyrene, polyethylene terephthalate, polyethylene naphthalate, triacetylcellulose, polyvinyl chloride, polyvinylidene chloride, polyimide, polycarbonate, cellophane, polynylon, and combinations thereof. The invention provides a light transmissive film wherein the at least one diffraction reducing agent is selected from the group consisting of Yellow Dye #5, Tartrazine, Pigment Yellow 14, Pigment Yellow 83, Pigment Yellow 155, Pigment Yellow 74, and combinations thereof. The invention provides a light transmissive film wherein the at least one absorbing polymer is selected from the group consisting of polyvinylpyrrolidone, cross-linked PVP, polyvinyl-alcohol, modified celluloses, methylcellulose, hydroxypropylmethylcellulose and hydroxyethyl-methylcellulose, ethylcellulose, ethylhydroxyethyl cellulose and hydroxybutyl cellulose, polyacrylamides, modified polyvinyl pyrrolidones, polyvinyl alcohol, modified polyvinyl alcohols methacrylamide; alkyltertiaryaminoalkylacryates and methacrylates; vinylpyridines such as 2-vinyl and 4-vinyl pyridines; preferably N-vinyl-2-pyrrolidone; acrylamide, methacrylamide and their N-monoalkyl and N,N-dialkyl derivatives thereof; hydroxyalkyl acrylate, methacrylate, and combinations thereof. The invention provides a light transmissive film wherein the at least one film-forming polymeric binder is selected from the group consisting of acrylic, cationic polymer dispersions, a cationic styrene-acrylic latex polymer, vinyl chloride-vinyl acetate copolymers, vinyl chloride-vinyl acetate-vinyl alcohol copolymers, vinyl chloride-vinyl acetate-maleic acid polymers, vinyl chloride-vinylidene chloride copolymers, vinyl chloride-acrylonitrile copolymers, acrylic ester-acrylonitrile copolymers, acrylic estervinylidene chloride copolymers, methacrylic estervinylidene chloride copolymers, methacrylic esterstylene copolymers, thermoplastic polyurethane resins, phenoxy resins, polyvinyl alcohol, polyvinyl fluoride, vinylidene, chloride-acrylonitrile copolymers, butadieneacrylonitrile copolymers, acrylonitrile-butadieneacrylic acid copolymers, acrylonitrile-butadienemethacrylic acid copolymers, polyvinyl butyral, polyvinyl acetal, cellulose derivatives, styrenebutadiene copolymers, polyester resins, phenolic resins, epoxy resins, thermosetting polyurethane resins, urea resins, melamine resins, alkyl resins, urea-formaldehyde resins, cellulose acetate, cellulose diacetate, cellulose triacetate, cellulose acetate butyrate, cellulose acetate propionate, and combinations thereof. The invention provides a light transmissive film wherein the at least one film-forming polymeric secondary binder is selected from the group consisting of acrylic, cationic polymer dispersions, a cationic styrene-acrylic latex polymer, vinyl chloride-vinyl acetate copolymers, vinyl chloride-vinyl acetate-vinyl alcohol copolymers, vinyl chloride-vinyl acetate-maleic acid polymers, vinyl chloride-vinylidene chloride copolymers, vinyl chloride-acrylonitrile copolymers, acrylic ester-acrylonitrile copolymers, acrylic estervinylidene chloride copolymers, methacrylic estervinylidene chloride copolymers, methacrylic esterstylene copolymers, thermoplastic polyurethane resins, phenoxy resins, polyvinyl alcohol, polyvinyl fluoride, vinylidene, chloride-acrylonitrile copolymers, butadieneacrylonitrile copolymers, acrylonitrile-butadieneacrylic acid copolymers, acrylonitrile-butadienemethacrylic acid copolymers, polyvinyl butyral, polyvinyl acetal, cellulose derivatives, styrenebutadiene copolymers, polyester resins, phenolic resins, epoxy resins, thermosetting polyurethane resins, urea resins, melamine resins, alkyl resins, urea-formaldehyde resins, cellulose acetate, cellulose diacetate, cellulose triacetate, cellulose acetate butyrate, cellulose acetate propionate, and combinations thereof. The invention provides a light transmissive film wherein the at least one filler dispersion is selected from the group consisting of Silica, colloidal silica, alumina or alumina hydrate, colloidal alumina, a surface-processed cation colloidal silica, aluminum silicate, magnesium silicate, magnesium carbonate, titanium dioxide, zinc oxide, calcium carbonate, kaoline, talc, clay, calcium sulfate, barrium sulfate, zinc sulfate, zinc carbonate, satin white, diatomaceous earth, synthetic amorphous silica, aluminum hydroxide, lithopone, zeolite, magnesium hydroxide, synthetic mica, polystyrene, polymethacrylate, polymethyl-methacrylate, elastomers, ethylene-vinyl acetate copolymers, polyesters, polyester-copolymers, polyacrylates, polyvinylethers, polyamides, polyolefines, polysilicones, guanamine resins, polytetrafluoroethylene, elastomeric styrene-butadiene rubber (SBR), elastomeric butadiene-acrylonitrile rubber (NBR), urea resins, urea-formalin resins, and combinations thereof. The invention provides a light transmissive film wherein the at least one coagulating agent is polymerised diallyldimethylammonium chloride (polyDADMAC). The invention provides a light transmissive film wherein the at least one wetting agent is selected from the group consisting of ethoxylated surfactants, polytetrafluoroalkylene surfactants, ethoxylated surfactants, Polytetrafluoroalkylene surfactants, polyethylene oxide-b-poly(tetrafluoroethylene)polymers, 2-(perfluoroalkyl)ethyl stearate, anionic lithium carboxylate fluorosurfactant, anionic phosphate fluorosurfactant, anionic phosphate surfactant, amphoteric quaternary ammonium-acetate fluorosurfactant, fluoroaliphatic polymeric esters, their derivatives, ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether, and combinations thereof.

The invention provides a method of making a light transmissive film having an ink receptive coating the method comprising the steps of: providing a support layer, coating the support layer with an ink receiving layer, wherein said ink receiving layer comprises: at least one absorbing polymer present at a concentration of about 0.10-50% by weight; at least one film-forming polymeric binder present at a concentration of about 0-30% by weight; at least one film-forming polymeric secondary binder present at a concentration of about 0-30% by weight; at least one filler dispersion present at a concentration of about 0.10-25% by weight; at least one coagulating agent present at a concentration of about 0.2-15% by weight; at least one wetting agent present at a concentration of about 0.1-1% by weight, thereby making a light transmissive film.

The invention provides a method of making a mask screen printing positive, the method comprising the steps of: i) providing a light transmissive film having an ink receptive coating comprising: a support layer, wherein the support layer is coated with an ink receiving layer, wherein said ink receiving layer comprises: at least one absorbing polymer present at a concentration of about 0.10-50% by weight; at least one film-forming polymeric binder present at a concentration of about 0-30% by weight; at least one film-forming polymeric secondary binder present at a concentration of about 0-30% by weight; at least one filler dispersion present at a concentration of about 0.10-25% by weight; at least one coagulating agent present at a concentration of about 0.2-15% by weight; at least one wetting agent present at a concentration of about 0.1-1% by weight ii) applying an image to the light transmissive film.

The invention provides a method of screen printing, the method comprising the steps of: i) providing a light transmissive film having an ink receptive coating comprising: a support layer, wherein the support layer is coated with an ink receiving layer, wherein said ink receiving layer comprises: at least one absorbing polymer present at a concentration of about 0.10-50% by weight; at least one film-forming polymeric binder present at a concentration of about 0-30% by weight; at least one film-forming polymeric secondary binder present at a concentration of about 0-30% by weight; at least one filler dispersion present at a concentration of about 0.10-25% by weight; at least one coagulating agent present at a concentration of about 0.2-15% by weight; at least one wetting agent present at a concentration of about 0.1-1% by weight ii) applying an image to the light transmissive film, thereby forming a mask, iii) applying the mask to a light-sensitive material, iv) exposing the mask and light sensitive material to a radiation source, forming a film master image, v) removing the mask, vi) removing the uncured light sensitive material, thereby forming a stencil.

The invention provides a light transmissive film having an ink receptive coating comprising: a support layer, wherein the support layer is coated with an ink receiving layer, wherein said ink receiving layer comprises: at least one polyvinyl alcohol present at a concentration of about 30-60% by weight; at least one film forming polymeric binder present at a concentration of about 30-60% by weight; at least one filler dispersion present at a concentration of about 10-30% by weight; at least one wetting agent present at a concentration of about 0.1-1% by weight. The invention provides a light transmissive film wherein the support layer is selected from the group consisting of polyolefin, polyester, polyamide, acrylic, polyurethane, polyethylene, polypropylene, polystyrene, polyethylene terephthalate, polyethylene naphthalate, triacetylcellulose, polyvinyl chloride, polyvinylidene chloride, polyimide, polycarbonate, cellophane, polynylon, and combinations thereof. The invention provides a light transmissive film wherein the at least one diffraction reducing agent is selected from the group consisting of Yellow Dye #5, Tartrazine, Pigment Yellow 14, Pigment Yellow 83, Pigment Yellow 155, Pigment Yellow 74, and combinations thereof. The invention provides a light transmissive film wherein the at least one film-forming polymeric binder is selected from the group consisting of acrylic, cationic polymer dispersions, a cationic styrene-acrylic latex polymer, vinyl chloride-vinyl acetate copolymers, vinyl chloride-vinyl acetate-vinyl alcohol copolymers, vinyl chloride-vinyl acetate-maleic acid polymers, vinyl chloride-vinylidene chloride copolymers, vinyl chloride-acrylonitrile copolymers, acrylic ester-acrylonitrile copolymers, acrylic estervinylidene chloride copolymers, methacrylic estervinylidene chloride copolymers, methacrylic esterstylene copolymers, thermoplastic polyurethane resins, phenoxy resins, polyvinyl alcohol, polyvinyl fluoride, vinylidene, chloride-acrylonitrile copolymers, butadieneacrylonitrile copolymers, acrylonitrile-butadieneacrylic acid copolymers, acrylonitrile-butadienemethacrylic acid copolymers, polyvinyl butyral, polyvinyl acetal, cellulose derivatives, styrenebutadiene copolymers, polyester resins, phenolic resins, epoxy resins, thermosetting polyurethane resins, urea resins, melamine resins, alkyl resins, urea-formaldehyde resins, cellulose acetate, cellulose diacetate, cellulose triacetate, cellulose acetate butyrate, cellulose acetate propionate, and combinations thereof. The invention provides a light transmissive film wherein the at least one filler dispersion is selected from the group consisting of Silica, colloidal silica, alumina or alumina hydrate, colloidal alumina, a surface-processed cation colloidal silica, aluminum silicate, magnesium silicate, magnesium carbonate, titanium dioxide, zinc oxide, calcium carbonate, kaoline, talc, clay, calcium sulfate, barrium sulfate, zinc sulfate, zinc carbonate, satin white, diatomaceous earth, synthetic amorphous silica, aluminum hydroxide, lithopone, zeolite, magnesium hydroxide, synthetic mica, polystyrene, polymethacrylate, polymethyl-methacrylate, elastomers, ethylene-vinyl acetate copolymers, polyesters, polyester-copolymers, polyacrylates, polyvinylethers, polyamides, polyolefines, polysilicones, guanamine resins, polytetrafluoroethylene, elastomeric styrene-butadiene rubber (SBR), elastomeric butadiene-acrylonitrile rubber (NBR), urea resins, urea-formalin resins, and combinations thereof. The invention provides a light transmissive film wherein the at least one wetting agent is selected from the group consisting of ethoxylated surfactants, polytetrafluoroalkylene surfactants, ethoxylated surfactants, Polytetrafluoroalkylene surfactants, polyethylene oxide-b-poly(tetrafluoroethylene)polymers, 2-(perfluoroalkyl)ethyl stearate, anionic lithium carboxylate fluorosurfactant, anionic phosphate fluorosurfactant, anionic phosphate surfactant, amphoteric quaternary ammonium-acetate fluorosurfactant, fluoroaliphatic polymeric esters, their derivatives, ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether, and combinations thereof.

The invention provides a method of making a light transmissive film having an ink receptive coating the method comprising the steps of: providing a support layer, coating the support layer with an ink receiving layer, wherein said ink receiving layer comprises: at least one polyvinyl alcohol present at a concentration of about 30-60% by weight; at least one film forming polymeric binder present at a concentration of about 30-60% by weight; at least one filler dispersion present at a concentration of about 10-30% by weight; at least one wetting agent present at a concentration of about 0.1-1% by weight, thereby making a light transmissive film.

The invention provides a method of making a mask screen printing positive, the method comprising the steps of: i) providing a light transmissive film having an ink receptive coating comprising: a support layer, wherein the support layer is coated with an ink receiving layer, wherein said ink receiving layer comprises: at least one polyvinyl alcohol present at a concentration of about 30-60% by weight; at least one film forming polymeric binder present at a concentration of about 30-60% by weight; at least one filler dispersion present at a concentration of about 10-30% by weight; at least one wetting agent present at a concentration of about 0.1-1% by weight ii) applying an image to the light transmissive film.

The invention provides a method of screen printing, the method comprising the steps of: i) providing a light transmissive film having an ink receptive coating comprising: a support layer, wherein the support layer is coated with an ink receiving layer, wherein said ink receiving layer comprises: at least one polyvinyl alcohol present at a concentration of about 30-60% by weight; at least one film forming polymeric binder present at a concentration of about 30-60% by weight; at least one filler dispersion present at a concentration of about 10-30% by weight; at least one wetting agent present at a concentration of about 0.1-1% by weight ii) applying an image to the light transmissive film, thereby forming a mask, iii) applying the mask to a light-sensitive material, iv) exposing the mask and light sensitive material to a radiation source, forming a film master image, v) removing the mask, vi) removing the uncured light sensitive material, thereby forming a stencil.

The invention provides a light transmissive film having an ink receptive coating comprising: a support layer, wherein the support layer is coated with an ink receiving layer, wherein said ink receiving layer comprises: at least one crosslinked polyvinylpyrrolidone (PVP) present at a concentration of about 10-25%; at least one polyvinyl alcohol present at a concentration of about 10-255% by weight; at least one film forming polymeric binder present at a concentration of about 0-30% by weight; at least one wetting agent present at a concentration of about 0.1-1% by weight. The invention provides a light transmissive film wherein the support layer is selected from the group consisting of polyolefin, polyester, polyamide, acrylic, polyurethane, polyethylene, polypropylene, polystyrene, polyethylene terephthalate, polyethylene naphthalate, triacetylcellulose, polyvinyl chloride, polyvinylidene chloride, polyimide, polycarbonate, cellophane, polynylon, and combinations thereof. The invention provides a light transmissive film wherein the at least one diffraction reducing agent is selected from the group consisting of Yellow Dye #5, Tartrazine, Pigment Yellow 14, Pigment Yellow 83, Pigment Yellow 155, Pigment Yellow 74, and combinations thereof. The invention provides a light transmissive film wherein the at least one film-forming polymeric binder is selected from the group consisting of acrylic, cationic polymer dispersions, a cationic styrene-acrylic latex polymer, vinyl chloride-vinyl acetate copolymers, vinyl chloride-vinyl acetate-vinyl alcohol copolymers, vinyl chloride-vinyl acetate-maleic acid polymers, vinyl chloride-vinylidene chloride copolymers, vinyl chloride-acrylonitrile copolymers, acrylic ester-acrylonitrile copolymers, acrylic estervinylidene chloride copolymers, methacrylic estervinylidene chloride copolymers, methacrylic esterstylene copolymers, thermoplastic polyurethane resins, phenoxy resins, polyvinyl alcohol, polyvinyl fluoride, vinylidene, chloride-acrylonitrile copolymers, butadieneacrylonitrile copolymers, acrylonitrile-butadieneacrylic acid copolymers, acrylonitrile-butadienemethacrylic acid copolymers, polyvinyl butyral, polyvinyl acetal, cellulose derivatives, styrenebutadiene copolymers, polyester resins, phenolic resins, epoxy resins, thermosetting polyurethane resins, urea resins, melamine resins, alkyl resins, urea-formaldehyde resins, cellulose acetate, cellulose diacetate, cellulose triacetate, cellulose acetate butyrate, cellulose acetate propionate, and combinations thereof. The invention provides a light transmissive film wherein the at least one wetting agent is selected from the group consisting of ethoxylated surfactants, polytetrafluoroalkylene surfactants, ethoxylated surfactants, polytetrafluoroalkylene surfactants, polyethylene oxide-b-poly(tetrafluoroethylene)polymers, 2-(perfluoroalkyl)ethyl stearate, anionic lithium carboxylate fluorosurfactant, anionic phosphate fluorosurfactant, anionic phosphate surfactant, amphoteric quaternary ammonium-acetate fluorosurfactant, fluoroaliphatic polymeric esters, their derivatives, ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether, and combinations thereof.

The invention provides a method of making a light transmissive film having an ink receptive coating the method comprising the steps of: providing a support layer, coating the support layer with an ink receiving layer, wherein said ink receiving layer comprises: at least one crosslinked polyvinylpyrrolidone (PVP) present at a concentration of about 10-25%; at least one polyvinyl alcohol present at a concentration of about 10-255% by weight; at least one film forming polymeric binder present at a concentration of about 0-30% by weight; at least one wetting agent present at a concentration of about 0.1-1% by weight, thereby making a light transmissive film. The invention provides a method of making a mask screen printing positive, the method comprising the steps of: i) providing a light transmissive film having an ink receptive coating comprising: a support layer, wherein the support layer is coated with an ink receiving layer, wherein said ink receiving layer comprises: at least one crosslinked polyvinylpyrrolidone (PVP) present at a concentration of about 10-25%; at least one polyvinyl alcohol present at a concentration of about 10-255% by weight; at least one film forming polymeric binder present at a concentration of about 0-30% by weight; at least one wetting agent present at a concentration of about 0.1-1% by weight ii) applying an image to the light transmissive film.

The invention provides a method of screen printing, the method comprising the steps of: i) providing a light transmissive film having an ink receptive coating comprising: a support layer, wherein the support layer is coated with an ink receiving layer, wherein said ink receiving layer comprises: at least one crosslinked polyvinylpyrrolidone (PVP) present at a concentration of about 10-25%; at least one polyvinyl alcohol present at a concentration of about 10-255% by weight; at least one film forming polymeric binder present at a concentration of about 0-30% by weight; at least one wetting agent present at a concentration of about 0.1-1% by weight ii) applying an image to the light transmissive film, thereby forming a mask, iii) applying the mask to a light-sensitive material, iv) exposing the mask and light sensitive material to a radiation source, forming a film master image, v) removing the mask, vi) removing the uncured light sensitive material, thereby forming a stencil.

### BRIEF DESCRIPTION OF SEVERAL VIEWS OF THE DRAWINGS

The patent or application file contains at least one drawing executed in color. Copies of this patent or patent application publication with color drawing(s) will be provided by the Office upon request and payment of the necessary fee. The invention will be described in conjunction with the following drawings in which like reference numerals designate like elements and wherein:

FIG. 1 is a magnified image showing Ulano emulsion FX88 on 305 white mesh, image exposed at 120 seconds/using Inventive yellow Inkjet positive. Observing the 50 u (micron) line (240% overexposed) magnification at 200× (computer illustration) still displays extremely good edge definition, resolution, and mesh bridging.

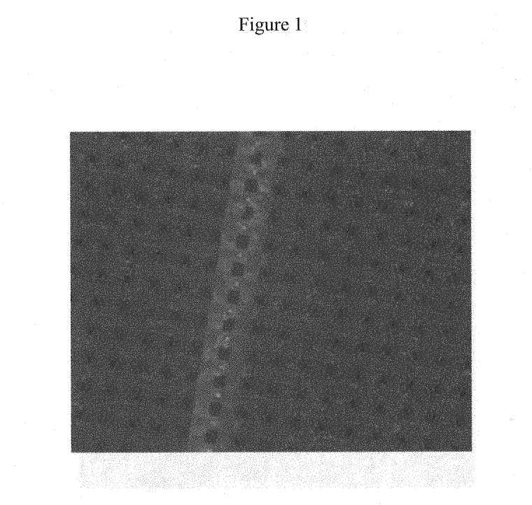

FIG. 2 is a magnified image showing Ulano emulsion FX88 on same screen/305 white mesh, image exposed only at 100 seconds/using Ulano Standard inkjet film/observing the 50 micron line (200% overexposed). Magnification @ 200× displays slightly rougher, wavy edges, there is emulsion growth which slightly closes the open area necessary for ink passage, resolution is not as good, therefore this screen would most likely not produce the same results as the one on FIG. 1

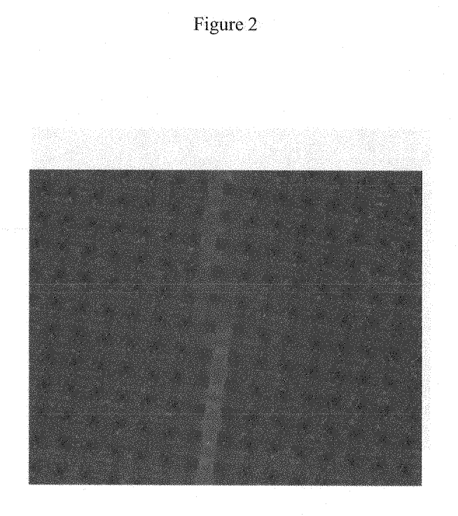

FIG. 3 is an enlarged image showing Ulano emulsion FX88 on 305 white mesh, but exposure is at 90 seconds (180% overexposed), Inkjet film utilizing Inventive clear. Observing 10% dot area, gives good resolution, good open area for ink flow and considerable edge definition. For detailed small area and detail which would be of great concern for graphic printers, this could or could not be acceptable, but at this rate of overexposure, these results show we still obtain very good latitude provided by the Inventive clear.

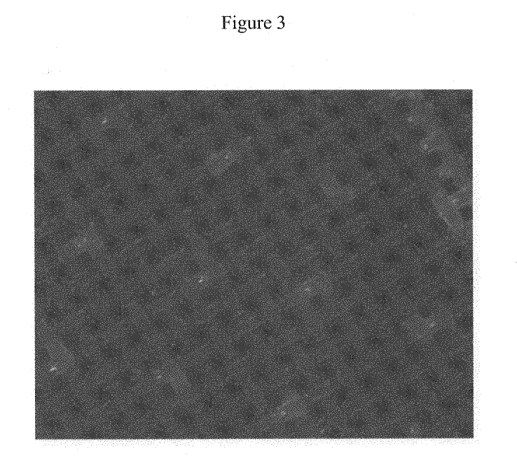

FIG. 4 is an enlarged image showing Ulano emulsion FX88/the same screen, same image, same exposure and parameters as above, except it's exposed with inkjet film with diffraction reducing yellow: we get overexposed results that would be comparable to optimal exposure, proving that diffraction reducing yellow is very effective in extending overall latitude of the emulsion. We observe an extremely well open area, hardly any extended growth, providing very good edge definition and barely any changes, extending very good resolution.

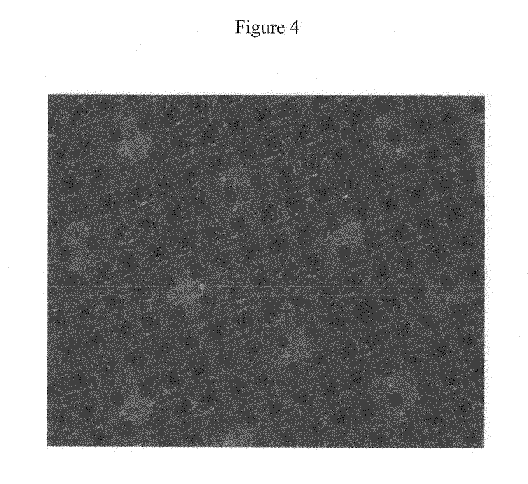

FIG. 5 is an enlarged image showing Ulano QT-50 lite which is a 50 u (micron) Capillary film/on 110 white mesh at 20 sec of exposure time. The inkjet film positive used—Inventive yellow. Pictured is 30% tonal range. SBQ pre-sensitized formulation allows the film to expose faster and more readily with a low intensity light source. SBQ films and emulsions do not give the same latitude or “forgiveness” that you will find with Diazo based emulsions (as FX88 above). There is very little “window of opportunity”, if you underexpose and especially overexpose. We chose this SBQ direct film to give clearer illustration of how the inventive mask will affect users applications. This film is used in the Textile industry, where specifications are not as crucial and perhaps more rudimentary than graphic production. However, customers would still appreciate wider tonal gamut (% dot of the halftone image fully reproducible on the screen). Here we demonstrate that over exposed by 25-30% of optimal exposure time film still retains very good edge definition, resolution and open area dimensions.

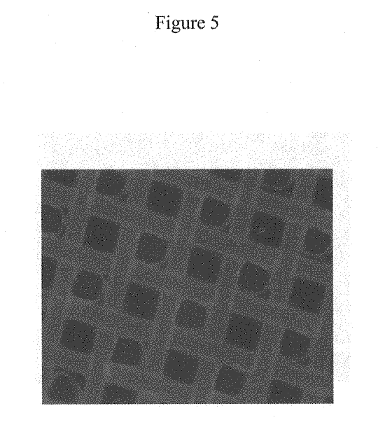

FIG. 6 is an enlarged image showing QT-50 lite on 110 white mesh, exposed at 20 seconds, Ulano Standard inkjet film positive, 200× magnification observing 30% dot area. Image shows a considerable change in just 5 seconds more exposure. The open area is now very limited, there is substantial growth due to undercutting, edge definition is grossly disturbed and the resolution is lost as a result.

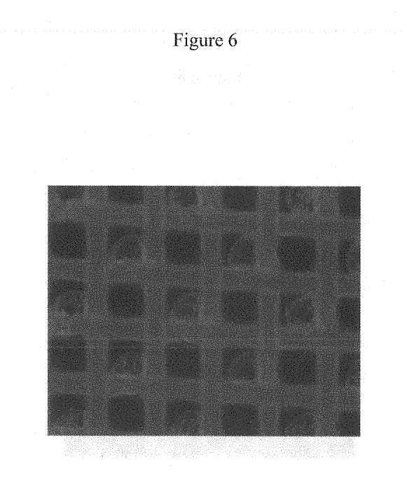

FIG. 7 is an enlarged image showing QT-50 Lite, 110 white mesh, same screen, at 70 second exposure, (450% overexposure) Inkjet image with diffraction reducing yellow. We observe the 50% dot area and remarkably we still get an open area and reasonable resolution. This image will still allow reasonable quality printing.

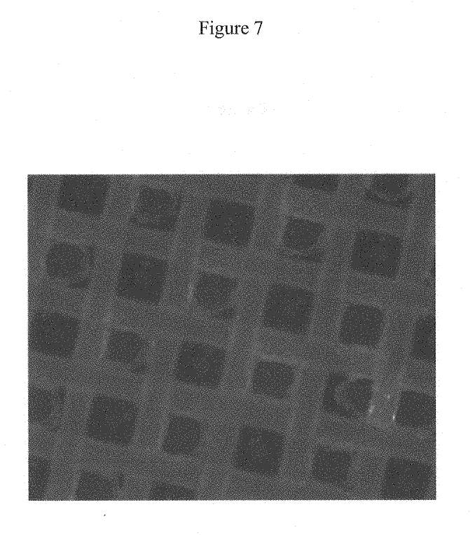

FIG. 8 is an enlarged image showing QT-50 lite, 110 mesh, same screen, same overexposure, Ulano standard Inkjet positive, we observe that the 50% dot area has closed up, the edges are clearly distorted. Printing through this stencil would not be possible at all.

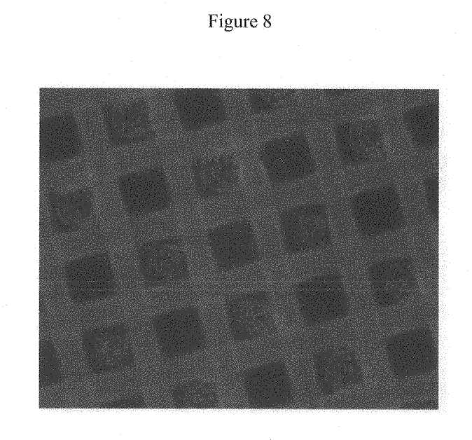

FIG. 9 is an enlarged image showing QTX emulsion a SBQ pure-photopolymer emulsion, once again is pre-sensitized. Designed for longer shelf life, exposes fast and works more readily with low intensity light sources, has substantially the same attributes as discussed previously in description with the QT film discussed, however, it is a liquid emulsion that has to be coated on the screen. This QTX is coated on a 110 mesh screen, optimal exposure time 15 seconds. This stencil was imaged utilizing the diffraction reducing yellow. We observe the 50 u (micron) line a distinct crisp defining edge, very good resolution and mesh bridging. The Diffraction reducing yellow mask held just a very slight edge over the Inventive clear and Ulano Standard (please refer to FIG. 10).

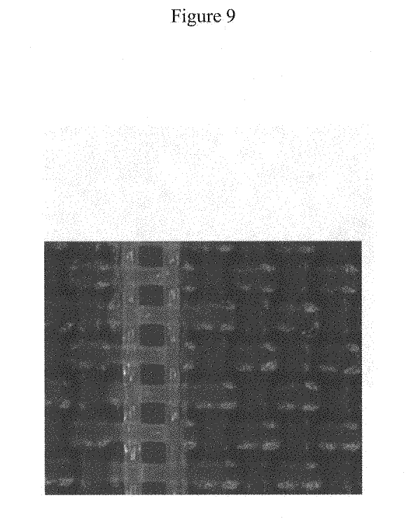

FIG. 10 is an enlarged image showing QTX emulsion on 110 white mesh the same screen at 15 second exposure. This image is on the Ulano Standard as observed the 50 u (micron) line there is a slight wavy edge; however resolution and mesh bridging are comparably good.

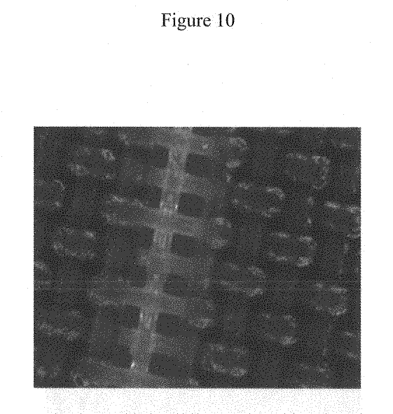

FIG. 11 is an enlarged image showing QTX emulsion on 110 white mesh, the same screen coated as above, exposure at 50 seconds now (350% overexposed) and remarkably this stencil exposed with Diffraction reducing yellow resolves the 50 u (micron) line extremely well. There is some crispness of the edge lost compared to the optimal exposure, there is some slight growth, but still reasonably good mesh bridging and open area that will conclude good printing for textile production.

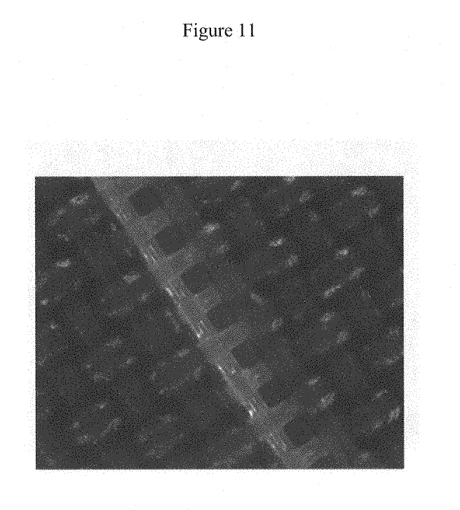

FIG. 12 is an enlarged image showing QTX emulsion, 110 white mesh, same screen, same percentage of overexposure, this inkjet positive used—Ulano Standard. This stencil as compared to stencil of FIG. 11 clearly shows the advantage of the diffraction reducing yellow. We observe the growth (propagation) of emulsion into open area, filling in open area almost completely, resolution loss and growth deterioration of edge definition. Stencil as depicted is useless. The Inventive clear mask at 50 seconds (not pictured) showed some slight improvement in comparison to the Ulano standard.

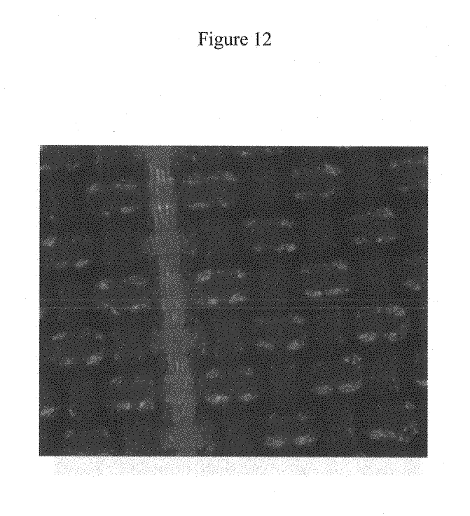

FIG. 13 is an enlarged image showing QTX emulsion on 110 mesh, exposed at 75 seconds, (500% overexposed) the inkjet image with Inventive yellow still holds a recognizable defined edge, there is some slight growth, but fair mesh bridging. Resolution is good and importantly there is open area.

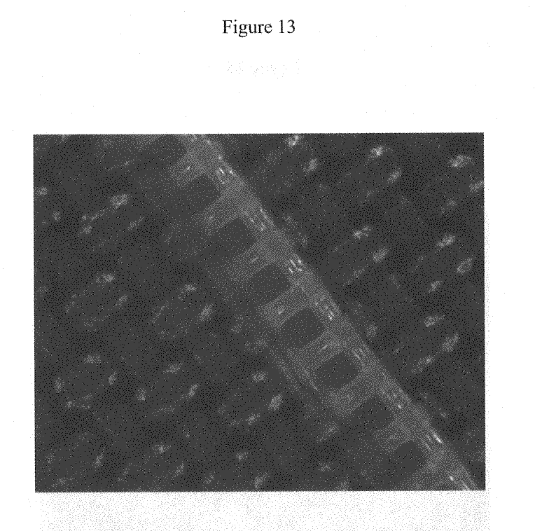

FIG. 14 is an enlarged image showing QTX on 110 mesh on this screen exposed at 75 seconds, inkjet image using Ulano Standard, growth is evident and has filled in the open area, resolution, mesh bridging and edge definition are failing, stencil is no longer printable.

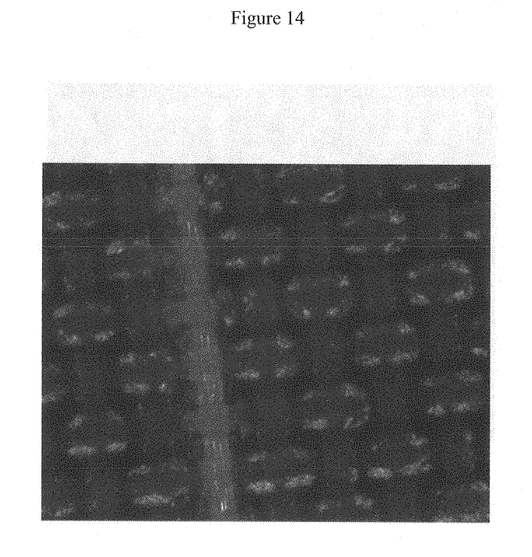

FIG. 15 shows QTX on 110 white mesh show comparison of inkjet image with Ulano Standard clear on this image. Image exposed for 30 seconds (200% overexposed). Good resolution, mesh bridging, edge definition has some roughness.

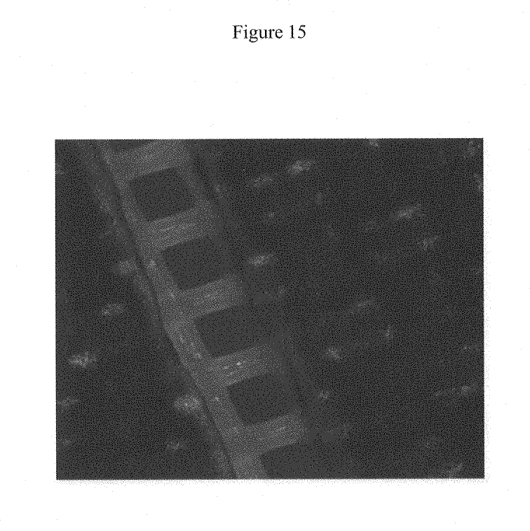

FIG. 16 shows QTX on 110 mesh, the same screen, same exposure, Inventive yellow as positive: A slight advantage, good resolution, edges are clean.

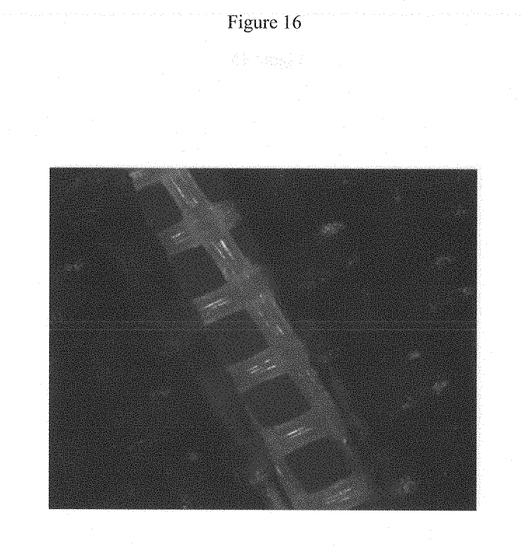

### DETAILED DESCRIPTION OF THE INVENTION

This invention combines light scattering filtration and imageable material in one product. As “masks” are created to convey information by transmission into light-sensitive materials, this invention proposes the coloration of the “mask” to create an anti-halation component with the purpose of collimating incident light.

As light approaching the “mask” at a lower incident angle will scatter in a greater degree and lose more intensity in passing through the body of the “mask” itself, the lower the angle of incidence, the greater portion of the light that will be absorbed. Conversely, the more perpendicular the incident light is, the greater the portion of the light that will be transmitted.

Thus, by including diffraction-reducing material, remaining transmitted light is effectively collimated.

Therefore broadly in accordance with the present invention there is provided a polymer film optionally selected from polyolefin, polyester, polyamide, acrylic, polystyrene, or polyurethane, where the film is coated with an ink-jet printable ink receiving layer which when ink-jet printed has an average percent increase in droplet size on the ink receiving layer of less than about 5% between about 0.1 and about 5 sec after printing.

Further embodiments and optional features of the present invention are provided in the claims herein.

Typical solvent based inks (i.e. non-aqueous system) can be inkjet printed onto uncoated PVC films. Typical solvent ink jet inks use vinyl resins and solvent systems such as glycols, glycol ethers and/or lactates that in-turn dissolve the PVC substrate to give good adhesive “key” to the dried print. Print quality is determined by ink-drop spread which is governed by relative substrate-ink surface energies (contact angle) and substrate-solvent interactions (dissolution/absorption) which will also be coat weight dependent.

In exemplary embodiments, the invention may, for example, be directed to:

a) External coloration, or by including light-range absorbing material of particular wavelengths within the substrate material of the transparency. Such substrates can be polyesters, polycarbonates, glass, polyethylene, polypropylene of various thickness, etc.;

b) Coating of the base substrate of the transparency with a special light absorbing layer that would have coloration and/or would include light-absorbing material in a particular wavelength range;

c) Coloration of, or the inclusion of particular wavelength range-light absorbing material in the imageable layer of the transparency. Such imageable layers could include inkjet receptive surfaces, diazo-sensitized or photoimageable surfaces, thermo-imageable layers, etc.;

d) Coloration of, or the inclusion of particular wavelength range light absorbing material within, the light-sensitive material of a stencil, cliché, or plate itself; and

e) Combining any 2 or 3 or all of the above.

### Support Layer

No particular limitation is imposed upon the material of which the support layer substrate film is made. Any material available for transparent films may be used as such to this end. Other materials may, of course, be employed. Although any solid substrate having a smooth surface can be used, a preferred substrate is a flexible and transparent plastic film. Plastic films, such as polyethylene, polypropylene, polyvinylchloride, polymethylmethacrylate, polyurethanes, nylons, polyesters, polycarbonates, polyvinylacetate, cellophane and esters of cellulose can be used as the transparent substrate. The most preferred substrates are the 15-300 microns thick films of polyethylene terephthalate, polycarbonate (polycarbonate of bisphenol-A), cellulose acetate and poly(vinylacetate) having high transparency (higher than 60%) and good dimensional stability.

Illustrative examples of the material of which the support layer substrate film is made include, for example, plastics such as polyester, polypropylene, cellophane, polycarbonate, cellulose acetate, polyethylene, polyvinyl chloride, polystyrene, nylon, polyimide, polyvinylidene chloride, and ionomer or their composite materials. In exemplary embodiments at least one diffraction reducing agent as defined herein can be added to the support layer. In exemplary embodiments a combination of diffraction reducing agents as defined herein can be added to the support layer.

Pigment Inkjet films may for example be coated on 5 mil polyester. The objects of the present invention are accomplished by the provision of, for example, polymeric coatings for transparent substrate support layers. More specifically, in accordance with the present invention there are provided, for example, a transparent substrate support layer, with coatings thereover, selected from the group consisting of poly(vinyl ethers), poly(alkyl methacrylates), and poly(alkyl acrylates) such as poly(acrylic acid esters), poly(methacrylic acid esters), and other polymers including poly(vinylmethyl ketone), poly(vinylacetate), and poly(vinylbutyral). Examples of transparent substrates selected include Mylar, commercially available from E. I. DuPont; Melinex, commercially available from Imperials Chemical Incorporated; Celanar, commercially available from Celanese; polycarbonates, especially Lexan; polysulfones; cellulose triacetates; polyvinyl chlorides; and the like, with Mylars being particularly preferred primarily in view of their availability and lower costs.

The transparent substrates illustrated herein are generally of a thickness of from about 50 microns to about 180 microns, and preferably of a thickness of from about 50 microns to about 70 microns. Thicknesses outside these ranges can be selected providing the objectives of the present invention are achieved.

In the present invention, as the support layer may be, for example, selected from the group consisting of polyolefin, polyester, polyamide, acrylic, polyurethane, polyethylene, polypropylene, polystyrene, polyethylene terephthalate, polyethylene naphthalate, triacetylcellulose, polyvinyl chloride, polyvinylidene chloride, polyimide, polycarbonate, cellophane, polynylon, and combinations thereof.

In the present invention, as the support, use can be made of supports conventionally employed in ink jet recording mediums, for example, a paper support such as plain paper, art paper, coated paper, cast coated paper, resin coated paper, resin impregnated paper, noncoated paper or coated paper; a paper support having its both sides or one side coated with polyethylene and/or a polyolefin such as polyethylene having titanium or other white pigment milled therein; a plastic support; and a support of nonwoven fabric, cloth, woven fabric, metal film, metal plate or composite consisting of a laminate of these.

For embodiments wherein the support layer is a plastic support, there can preferably be used, for example, a sheet or film of plastic such as polyethylene, polypropylene, polystyrene, polyethylene terephthalate, polyethylene naphthalate, triacetylcellulose, polyvinyl chloride, polyvinylidene chloride, polyimide, polycarbonate, cellophane or polynylon. Among these plastic supports, transparent, translucent, or opaque ones can appropriately be selected according to intended use.

### Ink Receiving Layer

The term “image-receiving layer”, “ink receiving layer”, “ink-retaining layer” or “ink receptive layer” is intended to define a layer that is used as a pigment-trapping layer, dye-trapping layer, or dye-and-pigment-trapping layer, in which, for example, a printed image substantially resides on the surface of or throughout the layer. Typically, an image-receiving layer comprises a mordant for dye-based inks. In the case of a dye-based ink, the image may optionally reside in more than one image-receiving layer.

In exemplary embodiments at least one diffraction reducing agent as defined herein can be added to the ink receiving layer. In exemplary embodiments a combination of diffraction reducing agents as defined herein can be added to the ink receiving layer.

The term “ink-receptive layer” or “ink-retaining layer” includes any and all layers above the support layer that are receptive to an applied ink composition, that absorb or trap any part of the one or more ink compositions used to form the image in the inkjet recording element, including the ink-carrier fluid and/or the colorant, even if later removed by drying. An ink-receptive layer, therefore, can include an image-receiving layer, where the image is formed by a dye and/or pigment, a base layer, or any additional layers, for example between a base layer and a topmost layer of the inkjet recording element. Typically, all layers above the support layer are ink-receptive. The support layer on which ink-receptive layers are coated may also absorb ink-carrier fluid, in which it is referred to as an ink-absorptive or absorbent layer rather than an ink-receptive layer. Image-recording elements (also termed herein, inkjet media or inkjet receivers) suitable for receiving ink from an inkjet printer may be used in sheet form and include plain paper, coated paper, synthetic paper, textiles, and films.

The ink receiving layer of the present invention may comprise a single relatively thick liquid-absorbent layer, or a two layer coating system having a thick base layer and a thin upper layer. Where a single layer is used, the thickness of the single layer preferably ranges from 10 mm to 40 mm Where a two-layer coating system is used, the base layer is the same thickness as when used alone, and the upper layer preferably has a thickness of from 0.5 mm to 10 mm.

The presence of polyethylene-acrylic copolymers in the ink absorbent layer, improves the dry time while maintaining good image quality. Preferred copolymers include those having at least 10% by weight acrylic acid content, more preferably at least 20% acrylic acid content.

Photographic quality image-recording media typically comprise a support layer, and coated upon the support layer, at least one image-receiving layer. The support layer may be any suitable support layer, such as plain paper, resin-coated paper, synthetic paper, or polymeric film. The support layer and the coating layer thereon may be opaque, semi-transparent or transparent, and their surfaces may be smooth or textured, depending on the type of display and illumination intended for viewing.

An inkjet recording media typically comprises a support layer having on at least one surface thereof at least one ink-receiving layer (IRL). There are generally two types of IRLs. The first type of IRL comprises a non-porous coating of a polymer with a high capacity for swelling, which non-porous coating absorbs ink by molecular diffusion. Cationic or anionic substances may be added to the coating to serve as a dye fixing agent or mordant for a cationic or anionic dye. Typically, the support layer is a smooth resin-coated paper and the ink-receiving layer is optically transparent and very smooth, leading to a very high gloss “photo-grade” inkjet recording media. However, this type of IRL usually tends to absorb the ink slowly and, consequently, the imaged receiver or print is not instantaneously dry to the touch.

The second type of ink-receiving layer or IRL comprises a porous coating of inorganic, polymeric, or organic-inorganic composite particles, a polymeric binder, and optional additives such as dye-fixing agents or mordants. These particles can vary in chemical composition, size, shape, and intra-particle porosity. In this case, the printing liquid is absorbed into the open interconnected pores of the IRL, substantially by capillary action, to obtain a print that is instantaneously dry to the touch. Typically the total interconnected inter-particle pore volume of porous media, which may include one or more layers, is more than sufficient to hold all the applied ink forming the image.

Inkjet printers can be used as a replacement for a high priced image setters and low quality laser printers. Making positives with an inkjet printer generally requires an absorbent coating on a film, such as a clear film, or a film comprising a diffraction reducing agent. Ulano Pigment Inkjet Film is designed to make positives. Modern inkjet inks are water based and still need time to evaporate and dry, just like a screen stencil. The stencil and the nano porous inkjet film have a strong capillary action, so if either holds any moisture, the ink can re-wet. In a stencil, this moisture is invisible and will interfere with cross linking, but when ink re-wets and bleeds, which can leads to poor results.

The required operating conditions for the best results is: Temperature for optimum performance 60°-80° F. (15°-25° C.). Required humidity for optimum performance 40%-60% Rh.

A dehumidifier or air conditioned room will achieve the best drying conditions. Start with the purchase of a hygrometer to measure relative humidity, (Rh %).

Ink is designed to dry slow. Inkjet ink manufacturers need to balance nozzle maintenance and the desire to have an ink that dries fast after printing. Glycol or glycerol humectants are added to the water based ink vehicle to keep the pigments in suspension, retard drying, and prevent nozzle blockage. This slows the evaporation of the inkjet ink in your art room.

Nano porous/micro porous Ulano Pigment Inkjet Film allows the solid particles in the pigment EPSON ink to penetrate the coating and appear dry to the touch, yet be wet inside. A dry stencil and dry positive is generally required or the combination of vacuum and moisture may damage a positive when the ink pulls out.

The ink receiving layer may comprise polymer coatings which may be are present on the substrate layer in various thicknesses, generally however, this thickness is from about 1 micron to about 5 microns, and preferably from about 1 micron to about 2 microns. The coatings are applied by known methods such as by a Keegen Coater, and dip coating.

One specific transparency of the present invention can be prepared by providing in a thickness of from about 50 to 100 microns a substrate layer, such as Mylar, which is then coated by dip coating techniques, with the polymers described herein, in a thickness of from about 1 micron to about 5 microns.

The ink receiving layer can be coated on a substrate layer using conventional or specialized coating techniques including a Bird type film applicator (doctors blade or knife over roll technique), gravure bars and wire wound rods. The wire wound rods provide a more uniform coating in the laboratory. A piece (e.g., 15×30 to 30×45 cm2) of polyester film is placed on the platform of a draw down machine (Precision Draw Down Machine, Paul Gardener Company, Pompano Beach, Fla.). An emulsion is poured in front of a wire wound rod (usually number 20 or 30). The rod is pulled at an even motion. The film is removed and the coating is allowed to dry at room temperature.

For best performance, the formulations and the processes for making the film should be optimized.

### Polymeric Film-Forming Binders

In exemplary embodiments at least one diffraction reducing agent as defined herein can be added to the polymeric film forming binder. In exemplary embodiments a combination of diffraction reducing agents as defined herein can be added to the polymeric film forming binder. Polymeric film-forming binders which may be used in the ink receiving layer coating include, for example, acrylic, cationic polymer dispersions, (Raycat HI Q 105, Specialty Polymers Inc., a cationic styrene-acrylic latex polymer), vinyl chloride-vinyl acetate copolymers, vinyl chloride-vinyl acetate-vinyl alcohol copolymers, vinyl chloride-vinyl acetate-maleic acid polymers, vinyl chloride-vinylidene chloride copolymers, vinyl chloride-acrylonitrile copolymers, acrylic ester-acrylonitrile copolymers, acrylic estervinylidene chloride copolymers, methacrylic estervinylidene chloride copolymers, methacrylic esterstylene copolymers, thermoplastic polyurethane resins, phenoxy resins, polyvinyl alcohol, polyvinyl fluoride, vinylidene, chloride-acrylonitrile copolymers, butadieneacrylonitrile copolymers, acrylonitrile-butadieneacrylic acid copolymers, acrylonitrile-butadienemethacrylic acid copolymers, polyvinyl butyral, polyvinyl acetal, cellulose derivatives, styrenebutadiene copolymers, polyester resins, phenolic resins, epoxy resins, thermosetting polyurethane resins, urea resins, melamine resins, alkyl resins, urea-formaldehyde resins and the like. Of the above, the cellulose derivatives may be used as binders for use in accordance with this invention. Cellulose derivatives include cellulose esters such as, for example, cellulose acetate, cellulose diacetate, cellulose triacetate, cellulose acetate butyrate, cellulose acetate propionate, and the like.

Organic solvents which may be used to dissolve the polymeric binder and as a coating solvent in the preparation of the ink receiving layer coating compositions include ketones, such as acetone, methyl ethyl ketone and cyclohexanone, alcohols, esters, such as ethyl acetate and butyl acetate, cellosolves, such as propylene glycol methyl ether, ethers, aromatic solvents, such as toluene, and chlorinated hydrocarbons solvents, such as carbon tetrachloride, chloroform, dichloromethane; tetrahydrofuran and ketoesters.

The ink receptive layer coating formulation may further comprise additional optional components, such as inorganic or organic particles, as long as the coating solid laydown and relative concentration requirements used in the invention are met. These can include, but are not limited to, kaolin clay, montmorillonite clay, delaminated kaolin clay, calcium carbonate, calcined clay, silica gel, fumed silica, colloidal silica, talc, wollastinite, fumed alumina, colloidal alumina, titanium dioxide, zeolites, or organic polymeric particles.

### Diffraction Reducing Agent

In certain exemplary embodiments, at least one diffraction reducing agent may be added to the ink receptive coating. In additional exemplary embodiments, at least one diffraction reducing agent may be added to the support layer. In additional exemplary embodiments, at least one diffraction reducing agent may be added to both the ink receptive coating and the support layer. In additional exemplary embodiments, at least one diffraction reducing agent may be added in a coating separate from the ink receptive layer. In additional exemplary embodiments, at least one diffraction reducing agent may be added in a coating layer opposite the ink receptive layer. In additional embodiments, a combination of diffraction reducing agents may be used in, for example, any one or more of the support layer, the ink receiving layer, or at least one separate layer.

Particularly preferable examples of a diffraction reducing agent include, for example, FD&C Yellow Dye #5 from SENSIENT® (5-oxo-1-(p-sulfophenyl)-4-[(p-sulfophenyl) azo]-2-pyrazoline-3-carboxylic acid, trisodium salt; Tartrazine). Tartrazine is a synthetic lemon yellow azo dye primarily used as a food coloring. It is also known as E number E102, C.I. 19140, FD&C Yellow 5, Acid Yellow 23, Food Yellow 4, and trisodium 1-(4-sulfonatophenyl)-4-(4-sulfonatophenylazo)-5-pyrazolone-3-carboxylate). Particularly preferable examples of a diffraction reducing agent include, for example, Sunsperse® Yellow 14 (YPD-9773), Alkylphenol ethoxylates (APE)-free surfactant stabilized dispersion, YPD-1183 Pigment Yellow 83 (21108), YPD-5510 Pigment Yellow 155 (20031), YPD-6074 Pigment Yellow 74 (11741), YPD-9773 Pigment Yellow 14 (21095) (Sun Chemical).

Particularly preferable examples of pigments having an absorption peak wavelength within the range of 400 nm<λₚ<460 nm include C.I. Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 120, Pigment Yellow 126, Pigment Yellow 127, Pigment Yellow 128, Pigment Yellow 139, Pigment Yellow 151, Pigment Yellow 154, Pigment Yellow 155, Pigment Yellow 173, Pigment Yellow 174, Pigment Yellow 175, Pigment Yellow 176, Pigment Yellow 180, Pigment Yellow 181, Pigment Yellow 185, Pigment Yellow 191, Pigment Yellow 194, Pigment Yellow 196 or Pigment Yellow 213, Pigment Yellow 214 and Pigment Yellow 217.

Pigments are available in a variety of colors and shades including but not limited to whites, blacks, reds, oranges, yellows, greens, blues, indigos, violets and combinations thereof. Inks of the present invention may include a single pigment colorant or a mixture of pigment colorants. As a non-limiting example, pigments may include, alone or in combination, pigment black 1, pigment black 6, pigment black 7 (carbon black), pigment black 8, pigment black 9, pigment black 10, pigment black 11 (iron oxide), pigment black 19, pigment black 31, pigment brown 6 (iron oxide), pigment red 60, pigment red 83, pigment red 88, pigment red 101 (iron oxide), pigment red 122, pigment red 171, pigment red 176, pigment red 177, pigment red 202, pigment red 264, pigment yellow 1, pigment yellow 3, pigment yellow 34, pigment yellow 35, pigment yellow 37, pigment yellow 40, pigment yellow 42 (iron oxide), pigment yellow 53, pigment yellow 65, pigment yellow 83, pigment yellow 95, pigment yellow 97, pigment yellow 108, pigment yellow 110, pigment yellow 120, pigment yellow 138, pigment yellow 139, pigment yellow 150, pigment yellow 151, pigment yellow 153, pigment yellow 154, pigment yellow 175, pigment yellow 184, pigment white 4, pigment white 6 (titanium dioxide), pigment green 17 (chromium oxide), pigment blue 36 (chromium aluminum cobaltous oxide), pigment blue 15 (copper phthalocyanine), pigment blue 15:1, pigment blue 15:3, pigment blue 15:6, pigment blue 16, pigment blue 17, pigment blue 27, pigment blue 28, pigment blue 29, pigment blue 33, pigment blue 35, pigment blue 36, pigment blue 60, pigment blue 72, pigment blue 73, pigment blue 74, pigment violet 11, pigment violet 19, pigment violet 23 (3,amino-9-ethyl carbazole-chloronil), pigment violet 42, Millikan ink yellow 869, Millikan ink blue 92, Millikan ink red 357 and Millikan ink black 8915-67, NR4, NR9, D&C Blue No. 6, D&C Green No. 6, D&C Violet No. 2, carbazole violet, phthalocyanine green, certain copper complexes, certain chromium oxides, and various iron oxides. See Marmiom D M Handbook of U.S. Colorants for a list of additional colorants or pigments that may be used alone or in combination.

### Absorbing Polymer

Coatings formulated with a mixture of PVP and either gelatin or polyvinyl alcohol have shown excellent characteristics. The coatings show high ink receptivity to aqueous inks with excellent resistance to puddling and freedom from tackiness. The reason for this superior performance appears to be that neither polyvinyl alcohol nor gelatin are dissolved by the ink. They are believed to retain their three-dimensional lattice structure in which the PVP is dispersed. When an ink droplet lands on the coating, the water first is rapidly taken up by the PVP. The water then moves into the matrix-forming polymer which can swell to accept the water from the ink as the lattice becomes hydrated.

In exemplary embodiments the ink receptive layer may comprise at least one absorbing polymer. The absorbing polymer may be for example, polyvinylpyrrolidone, cross-linked PVP, polyvinyl-alcohol, modified celluloses, methylcellulose, hydroxypropylmethylcellulose and hydroxyethyl-methylcellulose, ethylcellulose, ethylhydroxyethyl cellulose and hydroxybutyl cellulose, polyacrylamides, modified polyvinyl pyrrolidones, polyvinyl alcohol, modified polyvinyl alcohols methacrylamide; alkyltertiaryaminoalkylacryates and methacrylates; vinylpyridines such as 2-vinyl and 4-vinyl pyridines; preferably N-vinyl-2-pyrrolidone; acrylamide, methacrylamide and their N-monoalkyl and N,N-dialkyl derivatives thereof; hydroxyalkyl acrylate, methacrylate. In exemplary embodiments at least one diffraction reducing agent as defined herein can be added to the absorbing polymer. In exemplary embodiments a combination of diffraction reducing agents as defined herein can be added to the absorbing polymer.

Polyvinylpyrrolidone (PVP) has been found to have outstanding properties in regard to ink receptivity and minimization of puddling problems when used as a base sheet coating for transparent ink jet recording materials. When polyvinylpyrrolidone is used by itself as a coating, aqueous inks form an acceptable image, but dry slowly. For an extended period of time after the ink is applied, the image shows both wetness and tackiness, especially in areas of solid fill. Thus, sheets coated with PVP alone are not suitable for use in a high speed, automatically feeding printer. While we do not wish to be bound by any particular theory, it appears that the ink is actually dissolving part of the PVP coating, forming a viscous and tacky solution of PVP in the ink which must then dry by evaporation of the water with the coating reforming as the water leaves. This property also appears to be responsible for the excellent ink receptivity and resistance to puddling shown by PVP coatings. Apparently, the viscosity of each individual ink droplet on the film is increased by incorporation of the polymer and its resistance to moving from where it landed seems to be greatly increased as it begins to dissolve PVP.

In certain embodiments, the tackiness and puddling problems of PVP has been overcome by including a second polymer in the film forming mixture which is fully compatible with PVP but which has different solubility characteristics. We theorize that this second polymer forms a matrix in which the PVP is intimately mixed at a colloidal or molecular level. The second polymer should also be hydrophilic in nature but one that is not readily dissolved in water at room temperature. Gelatin and polyvinyl alcohol (PVA) are examples of polymers which have proved particularly satisfactory for this purpose. Both are soluble in hot water, and the mixture of PVP with either polyvinyl alcohol or gelatin can be cooled sufficiently so that the substrate or base sheet can be coated before the coating sets into a gel.

Polyvinylpyrrolidone is available as a commercial chemical from a number of suppliers. While the particular type used in the coating of the present invention does not appear to be critical, those with the highest molecular weights which still retain good water solubility at room temperature are the preferred materials. These generally should have molecular weights of 90,000 or greater, preferably about 350,000, and should not be crosslinked or be only lightly crosslinked in order not to adversely affect room temperature solubility in water. Molecular weights below 90,000 may be usable if thickening agents are included to increase the viscosity of the solution. Examples of such thickeners include naturally occurring gums, agarose, and polyacrylic acid polymers.

The ratio of polyvinylpyrrolidone to matrix-forming polymer is broadly critical, and compositions falling within the ratios of 3:1 to 1:3 appear to work satisfactorily. Generally, the best results have been obtained when the ratio of PVP to matrix-forming polymer is about 1:1. More specifically, the optimum ratio was about 1:1 for the best PVP:PVA mixture, and 3:2.5 for the best PVP:gel mixture. The rate of ink receptivity appears to increase with increasing amounts of PVP. However, drying time to achieve a nonsmearing image and the tendency to form tacky films also increases.

In addition, a composition of polyvinyl alcohol used as the matrix-forming polymer does appear to be broadly critical. If essentially fully hydrolyzed types are used, the PVA must have a molecular weight below 60,000 to obtain a transparent coating. Fully hydrolyzed polyvinyl alcohols having molecular weights of approximately 40,000 have given excellent performance in combination with PVP. Polyvinyl alcohols that are less than fully hydrolyzed, and thus have a greater percentage of acetate substitution, can be of a higher molecular weight. For example, excellent ink receptivity, drying times, and transparency are obtained with a 98 percent hydrolyzed polyvinyl alcohol of 79,000 molecular weight. When a high molecular weight PVA is used, it is necessary to increase the ratio of PVP to PVA in order to obtain a coating that is most hydrophilic. The optimum ratio of PVP to PVA can be determined by experiment. There is a limit to the degree of hydrolysis that can be allowed for the PVA. Below about 85 percent hydrolysis, PVA in a coating will cause a substantial decrease in ink receptivity.

The reason for these broad limitations on the nature of the polyvinyl alcohol lies in the nature of the film which they produce. The films rapidly lose transparency as molecular weight increases above the 60,000 range for a fully hydrolyzed polyvinyl alcohol. While this is not any particular problem when the present compositions are being used as a coating on many hydrophobic substrate materials, it is unacceptable for a recording material that is to be used as a transparency.

Preferred liquid absorbent hydrophilic polymeric compounds used in the single layer system, and base layer of the two-layer system, along with the polyethylene-acrylic acid polymer include uncrosslinked hydrophilic liquid absorbent polymers such as polyacrylamides, polyvinylpyrrolidone and modified polyvinyl pyrrolidones, polyvinyl alcohol and modified polyvinyl alcohols, and other hydrophilic and liquid absorptive polymers comprising copolymerizable monomers such as: a) nitrogen-containing hydrophilic, and water absorptive monomers selected from the group consisting of vinyl lactams such as N-vinyl-2-pyrrolidone; acrylamide, methacrylamide and their N-monoalkyl and N,N-dialkyl derivatives thereof; alkyltertiaryaminoalkylacryates and methacrylates; vinylpyridines such as 2-vinyl and 4-vinyl pyridines; preferably N-vinyl-2-pyrrolidone; acrylamide, methacrylamide and their N-monoalkyl and N,N-dialkyl derivatives thereof; and b) hydrophilic monomers selected from the group consisting of hydroxyalkyl acrylate and methacrylate, the alkyl group having from 1 to 5 carbon atoms, preferably from 1 to 2 carbon atoms, and more preferably hydroxyethyl acrylate and methacrylate; alkoxyalkyl acrylate and methacrylate, the alkyl group preferably ranging from 1 to 5 carbon atoms, preferably from 1 to 2 carbon atoms. The preferred material for the liquid absorbent layer is a blend of polyvinylpyrrolidone and polyethylene-acrylic acid. The preferred polyethylene-acrylic acids include those having 15-25% by weight acrylic acid content. The presence of a blend of polyvinylpyrrolidone (PVP-K-90) and a polyethylene-acrylic acid copolymer having 20% acrylic acid content, Primacor® 5980, in the liquid absorbent layer gives excellent dry times, especially when used in the two layer system with the preferred top layer constructions. The improved dry times are seen on essentially all ink jet printers.

The liquid absorbent layer can also comprise a crosslinked semi-interpenetrating network, or “SIPN”. The SIPN for this ink-receptive coating would be formed from polymer blends comprising (a) at least one crosslinkable polyethylene-acrylic acid copolymer, (b) at least one hydrophilic liquid absorbent polymer, and (c) a crosslinking agent.

An upper layer is also preferably present in addition to the liquid absorbent layer. This is applied on top of the liquid absorbent base layer. This top layer is usually thin, and comprises polymeric materials such as polyvinylpyrrolidone, polyvinyl-alcohol, modified celluloses, and mixtures thereof.

In one preferred embodiment, to maximize image quality and substantially eliminate mud-cracking with most pigmented-type inks, high viscosity modified cellulose binders such as methylcellulose, hydroxypropylmethylcellulose and hydroxyethyl-methylcellulose and mixtures thereof are preferred.

In this embodiment, certain cellulose derivatives are unsuitable as binders for elimination of mud-cracking include hydroxyethyl cellulose, hydroxymethyl cellulose, and carboxymethyl cellulose, although these may be used as additives when they comprise less than 40% of the overall cellulose content, or where mud-cracking is not prevalent, or critical. Cellulose derivatives less preferred as binders due to their hydrophobic nature, water insolubility, need for organic solvents, and tendency to cause coalescence of pigmented as well as colored ink jet inks include ethylcellulose, ethylhydroxyethyl cellulose and hydroxybutyl cellulose. These may again be used as additives with appropriate solvent blends when they comprise less than 40% of the overall cellulose content. Hydroxypropyl cellulose, although water soluble, is less suitable as a binder for the same reasons as the latter materials, although it may also be used as an additive when it comprises less than 40% of the overall cellulose content.

The upper layer can also comprise organic acid salts of polyethyleneimine for further improvements in the other properties including drytime, smudging of the images, image brightness and bleeding. Useful acids include dicarboxylic acid derivatives, containing 2-14 carbon atoms, phthalic acids, hydrochloric acid, boric acid, and substituted sulfonic acids, such as methanesulfonic acid, with preferred one being p-toluenesulfonic acid. The top layer may also comprise additives in addition to the celluloses mentioned above that can improve drytimes, color quality, tack, and the like, in greater quantities which do not degrade the mud-cracking performance of the pigmented ink. These additives include water soluble polymers such as poly-acrylic acid, polyvinylpyrrolidone, GAF Copolymer 845, polyethylene oxide, water soluble starches, e.g. Staylok® 500 and water soluble clays, e.g. Laponite® RDS as long as these additives comprise less than 40% of the topcoat solids. Other additives may include colloidal silica, boric acid, and surfactants.

Another additive which may be present to control curl is a plasticizing compound, which is added to the base layer of the film. Compounds can include low molecular weight polyethylene glycols, polypropylene glycols, or polyethers; for example PEG 600 or Pycal® 94.

The invention provides a coated transparency comprising an absorbing polymer coating wherein the absorbent polymer coating may be, for example, a water soluble material selected from the group consisting of (1) acrylamide-acrylic acid copolymers, (2) poly(acrylamide), (3) acrylic copolymer DP6-6066, acrylic copolymer DP6-7132 obtained from Allied Colloids, (4) poly(N,N-dimethyl acrylamide), and (5) poly(dimethyl acrylamide-acrylosarcosine methyl ester), #15776, available from Poly Sciences Inc.; and a supercoabsorber such as hydroxyalkyl starch, (1) methyl cellulose, (2) hydroxyethyl methyl cellulose, (3) hydroxy butylmethyl cellulose, (4) hydroxypropyl hydroxyethyl cellulose, (5) diethylammonium chloride hydroxy ethyl cellulose, (6) hydroxypropyl trimethyl ammonium chloride hydroxyethyl cellulose. (7) sodium carboxymethyl cellulose CMC 7HOF, (8) cellulose sulfate salts, (9) sodium carboxymethylhydroxyethyl cellulose CMHEC 43H and 37L, (10) polyacrylamide, and (11) polyethylene oxide; and mixtures thereof.

Examples of the first layer absorbent polymers preferably in contact with both lateral surfaces of the substrate include water soluble polymers, such as:

(A) superabsorbents, such as (1) acrylic acid-acrylamide copolymers, such as #04652, #02220, and #18545, available from Poly Sciences Inc., (2) poly(acrylamide), such as #02806, available from Poly Sciences Inc., (3) acrylic copolymer DP6-6066, acrylic copolymer DP6-7132, obtained from Allied Colloids, (4) poly(N,N-dimethyl acrylamide), such as #004590 available from Poly Sciences Inc, and (5) poly(dimethyl acrylamide-acrylosarcosine methyl ester), #15776, available from Poly Sciences Inc. Second polymers that may be present in the first layer include

(B) coabsorbent polymers, such as (1) starch, such as starch SLS-280 available from St. Lawrence starch; (2) cationic starch, such as Cato-72 available from National Starch; (3) hydroxyalkyl starch, wherein alkyl has at least one carbon atom and wherein the number of carbon atoms is such that the material is water soluble, preferably from about 1 to about 20 carbon atoms, and more preferably from about 1 to about 10 carbon atoms, such as methyl, ethyl, propyl, butyl, or the like, such as hydroxypropyl starch (#02382 available from Poly Sciences Inc., and hydroxyethyl starch (#06733 available from Poly Sciences Inc.); (4) gelatin, such as Calfskin Gelatin, #00639, available from Poly Sciences Inc.; (5) alkyl celluloses and aryl celluloses, wherein alkyl has at least one carbon atom, and wherein the number of carbon atoms is such that the material is water soluble, preferably from 1 to about 20 carbon atoms, more preferably from 1 to about 10 carbon atoms, and even more preferably from 1 to about 7 carbon atoms, such as methyl, ethyl, propyl, butyl, pentyl, hexyl, benzyl, and the like, such as methyl cellulose (Methocel AM 4 available from Dow Chemical Company), and wherein aryl has at least 6 carbon atoms and wherein the number of carbon atoms is such that the material is water soluble, preferably from 6 to about 20 carbon atoms, more preferably from 6 to about 10 carbon atoms, and even more preferably about 6 carbon atoms, such as phenyl; (6) hydroxy alkyl celluloses, wherein alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl, pentyl, hexyl, benzyl, or the like, such as hydroxyethyl cellulose, Natrosol 250 LR available from Hercules Chemical Company, and hydroxypropyl cellulose (Klucel Type E available from Hercules Chemical Company); (7) alkyl hydroxy alkyl celluloses, wherein each alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl, pentyl, hexyl, benzyl, or the like, such as ethyl hydroxyethyl cellulose, Bermocoll available from Berol Kem. A.B. Sweden; (8) hydroxy alkyl alkyl celluloses, wherein each alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl and the like, such as hydroxyethyl methyl cellulose (HEM available from British Celanese Ltd., also available as Tylose MH, MHK from Kalle A.G.), hydroxypropyl methyl cellulose (Methocel K35LV available from Dow Chemical Company), and hydroxy butylmethyl cellulose, such as HBMC available from Dow Chemical Company; (9) dihydroxyalkyl cellulose, wherein alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl and the like, such as dihydroxypropyl cellulose, which can be prepared by the reaction of 3-chloro-1,2-propane with alkali cellulose; (10) hydroxy alkyl hydroxy alkyl cellulose, wherein each alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl and the like, such as hydroxypropyl hydroxyethyl cellulose available from Aqualon Company; (11) halodeoxycellulose, wherein halo represents a halogen atom, such as chlorodeoxycellulose, which can be prepared by the reaction of cellulose with sulfuryl chloride in pyridine at 25.degree. C.; (12) amino deoxycellulose, which can be prepared by the reaction of chlorodeoxy cellulose with 19 percent alcoholic solution of ammonia for 6 hours at 160.degree. C.; (13) dialkylammonium halide hydroxy alkyl cellulose, wherein each alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl and the like, and wherein halide represents a halogen atom, such as diethylammonium chloride hydroxy ethyl cellulose, available as Celquat H-100, L-200, National Starch and Chemical Company; (14) hydroxyalkyl trialkyl ammonium halide hydroxyalkyl cellulose, wherein each alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl and the like, and wherein halide represents a halogen atom, such as hydroxypropyl trimethyl ammonium chloride hydroxyethyl cellulose available from Union Carbide Company as Polymer Jr; (15) dialkyl amino alkyl cellulose, wherein each alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl and the like, such as diethyl amino ethyl cellulose available from Poly Sciences Inc. as DEAE cellulose #05178; (16) carboxyalkyl dextrans, wherein alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl, pentyl, hexyl, and the like, such as carboxymethyl dextrans available from Poly Sciences Inc. as #16058; (17) dialkyl aminoalkyl dextran, wherein each alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl and the like, such as diethyl aminoethyl dextran available from Poly Sciences Inc. as #5178; (18) amino dextran (available from Molecular Probes Inc.); (19) carboxy alkyl cellulose salts, wherein alkyl has at least one carbon atom, and wherein the number of carbon atoms is such that the material is water soluble, preferably from 1 to about 20 carbon atoms, more preferably from 1 to about 10 carbon atoms, such as methyl, ethyl, propyl, butyl and the like, and wherein the cation is any conventional cation, such as sodium, lithium, potassium, calcium, magnesium, or the like, such as sodium carboxymethyl cellulose CMC 7HOF available from Hercules Chemical Company; (20) gum arabic, such as #G9752 available from Sigma Chemical Company; (21) carrageenan, such as #C1013 available from Sigma Chemical Company; (22) karaya gum, such as #G0503 available from Sigma Chemical Company; (23) xanthan, such as Keltrol-T available from Kelco division of Merck and Company; (24) chitosan, such as #C3646 available from Sigma Chemical Company; (25) carboxyalkyl hydroxyalkyl guar, wherein each alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl and the like, such as carboxymethyl hydroxypropyl gua, available from Auqualon Company; (26) cationic guar, such as Celanese Jaguars C-14-S, C-15, C-17 available from Celanese Chemical Company; (27) n-carboxyalkyl chitin, wherein alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl and the like, such as n-carboxymethyl chitin; (28) dialkyl ammonium hydrolyzed collagen protein, wherein alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl and the like, such as dimethyl ammonium hydrolyzed collagen protein, available from Croda as Croquats; (29) agar-agar, such as that available from Pfaltz and Bauer Inc.; (30) cellulose sulfate salts, wherein the cation is any conventional cation, such as sodium, lithium, potassium, calcium, magnesium, or the like, such as sodium cellulose sulfate #023 available from Scientific Polymer Products; (31) carboxyalkylhydroxyalkyl cellulose salts, wherein each alkyl has at least one carbon atom and wherein the number of carbon atoms is such that the material is water soluble, preferably from 1 to about 20 carbon atoms, more preferably from 1 to about 10 carbon atoms, such as methyl, ethyl, propyl, butyl and the like, and wherein the cation is any conventional cation, such as sodium, lithium, potassium, calcium, magnesium, or the like, such as sodium carboxymethylhydroxyethyl cellulose CMHEC 43H and 37L available from Hercules Chemical Company; (32) poly(oxyethylene) or poly(ethylene oxide), such as POLY OX WSRN-3000 available from Union Carbide Corporation; (33) ethylene oxide/2-hydroxyethyl methacrylate/ethylene oxide and ethylene oxide/hydroxypropyl methacrylate/ethylene oxide triblock copolymers, which can be synthesized via free radical polymerization of hydroxyethyl methacrylate or hydroxypropyl methacrylate with 2-aminoethanethiol using α,α′-azobisisobutyronitrile as initiator, and reacting the resulting amino-semitelechelic oligo-hydroxyethyl methacrylate or amino-hydroxypropyl methacrylate with an isocyanate-polyethylene oxide complex in chlorobenzene at 0° C., and precipitating the reaction mixture in diethylether, filtering and drying in vacuum; (34) ethylene oxide/4-vinyl pyridine/ethylene oxide triblock copolymers, which can be synthesized via anionic polymerization of 4-vinyl pyridine with sodium naphthalene as initiator at −78.degree. C. and then adding ethylene oxide monomer, the reaction being carried out in an explosion proof stainless steel reactor, ionene/ethylene oxide/ionene triblock copolymers, which can be synthesized via quaternization reaction of one end of each 3-3 ionene with the halogenated, preferably brominated, poly(oxyethylene) in methanol at about 40° C.; (35) ethylene oxide/isoprene/ethylene oxide triblock copolymers, which can be synthesized via anionic polymerization of isoprene with sodium naphthalene in tetrahydrofuran as solvent at −78° C., and then adding monomer ethylene oxide and polymerizing the reaction for three days, after which time the reaction is quenched with methanol, the ethylene oxide content in the aforementioned triblock copolymers being from about 20 to about 70 percent by weight and preferably about 50 percent by weight; and the like, as well as mixtures thereof.

### Filler Dispersion

In another illustrative example, the ink receiving layer or coating or top coat layer may be placed between the substrate and laminate layer on the image receiving side of the support layer. The top coat may comprise non-film forming polymers from one of the following polymer groups: styrene, acrylic, styrene/acrylics, vinyl/acetate, poly acrylics, methacrylates or combinations thereof. The glass transition temperature (Tg) for these non-film forming polymers is greater than approximately 50° C. In another example, the Tg of these non-film forming polymers is greater than approximately 75° C. In yet another example, the Tg of these non-film forming polymers is greater than approximately 100° C. Specific examples of these polymers may include, for example, a styrene acrylic emulsion polymer sold under the trade name RAYCAT® 29033, a polyacrylic emulsion polymer sold under the trade name RAYCAT® 78, and an acrylic emulsion polymer sold under the trade name RAYCRYL® 30S available from Specialty Polymers, Inc. These polymers improve printability and ink or toner adhesion. Further, the top coat may comprise pigments such as, for example, relatively small particles of a clay, a synthetic clay, precipitated calcium carbonate (PCC), titanium dioxide (TiO₂), plastic pigments such as, for example, DOW HS 3020 NA available from Dow Corning Co. (DOW), or combinations thereof. Further, the top coat may include water dispersible binders such as Acronal 5504, Acronal 5728, Raycryl 48083, water soluble binders such as polyvinyl alcohol (PVA), starch, and other functional additives such as slip aids and defoamers, among others.

In exemplary embodiments at least one diffraction reducing agent as defined herein can be added to the filler dispersion. In exemplary embodiments a combination of diffraction reducing agents as defined herein can be added to the filler dispersion.

As filler, inorganic and/or organic particles can be used. Useful examples of inorganic fillers are represented by silica (colloidal silica), alumina or alumina hydrate (aluminazol, colloidal alumina, a cation aluminum oxide or its hydrate and pseudo-boehmite), a surface-processed cation colloidal silica, aluminum silicate, magnesium silicate, magnesium carbonate, titanium dioxide, zinc oxide, calcium carbonate, kaoline, talc, clay, calcium sulfate, barrium sulfate, zinc sulfate, zinc carbonate, satin white, diatomaceous earth, synthetic amorphous silica, aluminum hydroxide, lithopone, zeolite, magnesium hydroxide and synthetic mica. Of these inorganic pigments, porous inorganic pigments are preferable such as porous synthetic crystalloid silica, porous calcium carbonate and porous alumina.

Useful examples of organic fillers are represented by polystyrene, polymethacrylate, polymethyl-methacrylate, elastomers, ethylene-vinyl acetate copolymers, polyesters, polyester-copolymers, polyacrylates, polyvinylethers, polyamides, polyolefines, polysilicones, guanamine resins, polytetrafluoroethylene, elastomeric styrene-butadiene rubber (SBR), elastomeric butadiene-acrylonitrile rubber (NBR), urea resins, urea-formalin resins. Such organic fillers may by used in combination, and/or in place of the above-mentioned inorganic fillers.

The above-described inorganic and/or organic fillers ordinarily make up to 20 weight % and preferably up to 10 weight % based on the solid content of the ink receiving layer compositions. Preferably, the resulting ink receiving layers totally comprise a filler amount of from 0.1 to 5 g/m2, preferably from 0.2 to 3 g/m2, most preferably from 0.3 to 1 g/m2.

### Coagulating Agent

To make a coating suitable for use with water based inkjet inks having anionic dye as colorant, a cationic fixative may be added to the paper coating. The cationic fixative is typically a soluble polymer with a polyvalent cationic functional group. One commonly used cationic fixative is polymerised diallyldimethylammonium chloride (polyDADMAC).

In exemplary embodiments at least one diffraction reducing agent as defined herein can be added to the coagulating agent. In exemplary embodiments a combination of diffraction reducing agents as defined herein can be added to the coagulating agent.

In an alternative coating color or pigmented coating suitable for use with water based inkjet inks having anionic dye as colorant described herein, a cationic binder may be used. The cationic binder acts as a binder and also as a cationic fixative. This allows the amount of a separate cationic fixative (such as polyDADMAC) to be reduced or, optionally, the coating might not have a separate cationic fixative. Instead, the coating may consist essentially of a cationic binder and pigment, optionally with various other non-fixative additives as described above.

A cationic binder can be provided, for example, by way of cationic cooked starch or a functionalized conventional synthetic latex binder such as PVOH. A preferred cationic binder is made of a dispersion of cationic biopolymer particles. The biopolymers typically do not exist in nature as particles that, in dispersion, have material binding activity. However, the biopolymers may be regenerated from their naturally occurring form into a latex forming, or at least readily dispersible, particle. Such a re-formed particle may be referred to as a regenerated biopolymer particle. The regenerated cationic biopolymer particles can be used as a binder for pigment in a coating color or pigmented coating, as a cationic fixative, or both.

The amount of the coagulant contained in the receptive layer is usually from 1 to 70 wt. parts, preferably from 3 to 50 wt. parts, per 100 wt. parts of the ink-fixing polymer. Further, as the chemical compound, a coagulating agent such as inorganic electrolyte, organic acid, inorganic acid or organic amine can be used.

As the coagulating agent, a single agent or a mixture of two or more agents may be used. Further, the content of the coagulating agent is desirably 0.01 to 30% by mass, or more desirably, 0.1 to 15% by mass, and further desirably, 1 to 15% by mass. The image-receptive layer may optionally contain a water-soluble salt (a salt of an organic or inorganic acid) as a coagluating agent. The coagulating agent coagulates the inks on the surface of the image-receptive layer and improves the quick drying properties, when the aqueous inks are applied (printed) on the surface of the medium.

The thickness of the image-receptive layer is preferably from 5 to 200 μm, more preferably from 10 to 100 μm. When the image-receptive layer is too thin, the ink-absorbing absorbing ability is insufficient so that the color development of the images decreases. When the image-receptive layer is too thick, the surface area of the edge part unnecessarily increases so that the water resistance tends to decrease, and thus the edge seal treatment may be necessary in the case of outdoor use of the image-recording medium.

Generally, when mixing a solvent solution of such a water insoluble polymer with an aqueous solution of such a hydrophilic polymer, a coagulate forms. Upon further stirring, the coagulate breaks down to form a viscous suspension. For example, an admixture of a solvent solution of a carboxylated styrene-acrylic acid copolymer, e.g., such as available under the trademark Joncryl 678, with an aqueous solution of N-vinyl pyrrolidone/N,N-dimethyl amino ethyl methacrylate copolymer, e.g., such as available under the trademark GAF copolymer 937, forms an immediate coagulate. Upon further stirring, the coagulate breaks down to a viscous milk-like suspension.

The coagulating agent for the polyvinyl alcohol may be “fully hydrolyzed” PVOH as being 95-99% hydrolyzed and defines “partially hydrolyzed” PVOH as being 80-95% hydrolyzed. Partially hydrolyzed PVOH actually comprises a co-polymer of polyvinyl alcohol and polyvinyl acetate.) Boric acid may be incorporated in the base sheet, or applied as a coating to the support layer, or incorporated in the absorbent filler/PVOH coating composition. In the latter instance, it is said that the boric acid must be deactivated before application to the substrate and reactivated upon application, inasmuch as the gelling of the binder has to take place during the coating operation and not before.

Coagulating Film resin may include Polyvinyl chloride THF-Water, Polymothyl mothacrylate Acetone-water, MEK-MeOH Polyvinyl chloride-THF-MeOH Water, polyvinylidene chloride copolymer Dioxane-MeOH Cellulose triacetate Acetone Water, ROH Polypropylene Carbon tetrachloride ROH In the above tables and throughout the balance of this specification MIBK means methyl isobutyl ketone, MeOH means methyl alcohol, TI-IF means tetrahydrofuran, CYX means cyclohexanone, and ROI-I means a lower alcohol.

### Wetting Agent

In addition to the above-mentioned the present ink receptive layer may for example include a wetting package configured to enhance the wetting of the resulting ink on a desired substrate. According to one exemplary embodiment, the wetting package includes, but is in no way limited to, between approximately 0.1 and 5.0% wetting agent, such as a fluorosurfactant, between approximately 0.5% and 15.0% wetting agent such as glycol ether, and between approximately 0.5% and 15.0% wetting agent such as 1,2-alkanediols.

In exemplary embodiments at least one diffraction reducing agent as defined herein can be added to the wetting agent. In exemplary embodiments a combination of diffraction reducing agents as defined herein can be added to the wetting agent.

More specifically, according to one exemplary embodiment, the wetting package includes between approximately 0.1% and 5.0% wetting agent, such as fluorosurfactant. According to this exemplary embodiment, the fluorosurfactant is configured to reduce the surface tension of the resulting inkjet ink, while enhancing the wetting properties thereof. As used herein, the fluorosurfactant used in the present exemplary wetting package may include, but is in no way limited to anionic fluorosurfactants, nonionic fluorosurfactants, or combinations of anionic and nonionic fluorosurfactants.

According to one exemplary embodiment, acceptable anionic fluorosurfactants may be incorporated into the present wetting package. Acceptable anionic fluorosurfactants may include, but are in no way limited to, the commercially available Zonyl® line of fluorosurfactants produced by E.I. Dupont de Nemours and Co. such as Zonyl® FSJ and Zonyl® FS-62; the commercially available Masurf FS-710 and Masurf FS-780 produced by the Mason Chemical Company; and commercially available Unidyne NS-1102 produced by Daikin Industries, LTD.

Additionally, nonionic fluorosurfactants may be included in the present exemplary inkjet ink formulation. More specifically, according to one exemplary embodiment, the nonionic fluorosurfactant that may be included in the present exemplary inkjet ink formulation includes, but is in no way limited to, commercially available nonionic fluorosurfactants such as Zonyl® FSO, FSN, FS-300 produced by E.I. DuPont de Nemours and Co., and 3M™ Novec™ fluorosurfactants including FC-4430, FC-4432, and FC-4434. According to one exemplary embodiment, the Novec™ nonionic fluorosurfactants may be selected due to their noted environmental benefits. More specifically there have recently been concerns about bioaccumulation of perfluorooctanyl surfactants in the environment, the building blocks of many common fluorosurfactants used in inkjet inks. However, Novec™ surfactants are polymeric nonionic fluorosurfactants based on perfluorobutane sulfonates, rather than the higher fluorocarbon chains used in other surfactants. Consequently, Novec™ FC-4432 and FC-4430 have low toxicity and do not bioconcentrate, while providing similar wetting and anti-puddling performance as the nonionic Zonyl fluorosurfactants. Additionally, as mentioned previously, combinations of the above-mentioned anionic or nonionic surfactants may be used in the present inkjet ink formulations.

Fluorosurfactants are surfactants that can either be ionic (with the fluorine-containing moiety being part of either the cationic or the anionic part) or nonionic (such as fluorocarbon chain-containing alcohols). The fluorosurfactants can be ethoxylated surfactants (i.e., polyethyleneoxide modified) or polytetrafluoroalkylene surfactants. Ethoxylated surfactants include one or more of ethylene oxide monomeric units. Polytetrafluoroalkylene surfactants include one or more of tetrafluoroalkylene units. Examples of fluorosurfactants include polyethylene oxide-b-poly(tetrafluoroethylene)polymers, 2-(perfluoroalkyl)ethyl stearate, anionic lithium carboxylate fluorosurfactant, anionic phosphate fluorosurfactant, anionic phosphate surfactant, amphoteric quaternary ammonium-acetate fluorosurfactant, fluoroaliphatic polymeric esters, their derivatives, and their mixtures. Examples of commercial fluorosurfactants include Zonyl family of fluorosurfactants (e.g., Zonyl FSO 100, Zonyl FSN, Zonyl FTS) and Capstone family of fluorosurfactants (available from DuPont Chemicals, Wilmington, Del.), or Fluorad FC 170-C, FC171, FC430 and FC431 available from 3M of St. Paul, Minn. Hermansky (see above) discloses the complete drying of the inks in the presence of Zonyl FSX surfactant.

In addition to the above-mentioned fluorosurfactant, a glycol ether may be provided in the present exemplary vehicle in quantities ranging from approximately 0.5% to 15.0%. According to one exemplary embodiment, the glycol ethers may be included in the vehicle formulation to serve as co-solvent wetting agents. Appropriate glycol ethers include, but are in no way limited to, ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether.

The laminate may comprise non-film forming polymers from one of the following polymer groups: styrene, acrylic, styrene/acrylics, vinyl/acetate, poly acrylics, methacrylates or combinations thereof. Specific examples of these polymers may include, for example, a styrene acrylic emulsion polymer sold under the trade name RAYCAT® 29033, a polyacrylic emulsion polymer sold under the trade name RAYCAT® 78, and an acrylic emulsion polymer sold under the trade name RAYCRYL® 30S available from Specialty Polymers, Inc. These polymers improve printability and ink or toner adhesion. Further, the top coat may comprise pigments such as, for example, relatively small particles of a clay, a synthetic clay, precipitated calcium carbonate (PCC), titanium dioxide (TiO₂), plastic pigments such as, for example, DOW HS 3020 NA available from Dow Corning Co. (DOW), or combinations thereof. Further, the top coat may include water dispersible binders such as Acronal 5504, Acronal 5728, Raycryl 48083, water soluble binders such as polyvinyl alcohol (PVA), starch, and other functional additives such as slip aids and defoamers, among others.

### Ink

The newest printers use pigment ink instead of dye ink because it resists fading for up to 99 years. This improves family snapshots, but doesn't help the making of UV opaque positives. The nano porous structure of the coating controls the ink spread for image sharpness. Pigment ink particles are coated with a resin so they can be controlled with piezo print heads.

Modern inkjet inks used for positives are water based and still need time to evaporate and dry. Ink manufacturers need to balance nozzle maintenance and the desire to have an ink that dries fast after printing, so a positive can be used to make a screen. Glycol or glycerol humectant additives in the water based carrier that are used to keep the pigments in suspension, retard drying, and prevent nozzle blockage need to evaporate the same way stencil coatings need to dry.

In exemplary embodiments at least one diffraction reducing agent as defined herein can be added to the ink. In exemplary embodiments a combination of diffraction reducing agents as defined herein can be added to the ink.

Often, nano porous or micro porous coatings are mistakenly called water proof. If you lick your fingers and pinch a piece of film, you will make one side sticky as it absorbs the moisture with capillary action. Dye inks re-wet and bleed if you get water on them. When the majority of inkjet printers used water based dye ink, suppliers started selling the more expensive micro porous coating as “water proof” to printers who wanted to pay for a safer coating in case their staff spill something on the positive. Pigment Inkjet Films are made to absorb water based inks, but they are not waterproof, rather they are “bleed-resistant”.

Polymeric dispersants are also known and useful in aqueous pigment-based ink compositions. Polymeric dispersants include polymers such as homopolymers and copolymers; anionic, cationic or nonionic polymers; or random, block, branched or graft polymers. The copolymers are designed to act as dispersants for the pigment by virtue of the arrangement and proportions of hydrophobic and hydrophilic monomers.

The pigment particles are colloidally stabilized by the dispersant and are referred to as a polymer dispersed pigment dispersion. Polymer stabilized pigment dispersions have the additional advantage offering image durability once the inks are dried down on the ink receiver substrate.

Preferred copolymer dispersants are those where the hydrophilic monomer is selected from carboxylated monomers. Preferred polymeric dispersants are copolymers prepared from at least one hydrophilic monomer that is an acrylic acid or methacrylic acid monomer, or combinations thereof. Preferably, the hydrophilic monomer is methacrylic acid.

Operating Specifications Required temperature for optimum performance 60°-80° F. (15°-25° C.); Required humidity for optimum performance 40%-60% RH; (Note: High humidity will prolong the drying time or the ability to absorb ink)

In preferred embodiments, Ink dries on the nano particles of the coating; Very fast drying and instantly dry to the touch Anti-Static Coating prevents sheets from sticking together; Absorbent Coating prevents ink moisture from sticking to stencil materials under vacuum contact.

Pigment or Dye ink is absorbed into the coating by capillary action and stains the microscopic particles in the coating. It appears to be dry to the touch, but the liquid carrier still has to evaporate. A benefit of the nano porous coating is that the positive can be stacked and handled very quickly. If it is a humid day, the ink might not dry and the vacuum of the exposure unit can pull the wet ink out of the film coating and stain the stencil during exposure, because the positive has lost some ink during the process, it shouldn't be used again.

The invention will be illustrated in more detail with reference to the following Examples, but it should be understood that the present invention is not deemed to be limited thereto.

### EXAMPLES

### Inkjet Receptive Coating Compositions

### Example #1

An inkjet receptive composition was prepared as follows:
A—0.10-50% by weight of absorbing polymer, such as crosslinked PVP (ViviPrint 540, Viviprint 200, Viviprint PS-10 from Ashland Specialty Chemicals or similar),
B— 0-30% by weight of film forming polymeric binder, such as Cationic Acrylic Dispersions (RayCat 105 from Speciality Polymers Products or similar)
C—0-30% by weight of film-forming polymeric secondary binder such as Cationic Polyurethane Dispersion (Witcobond 213, 214 PUD or similar)
D—0.10-25% by weight Cationic or non-ionic filler dispersion (Raycal-29033 from Specialty Polymer Products or similar)
E—0.2-15% by weight Coagulating agents, such as PolyDADMAC (Superfloc S-500 from Kemira or Similar)
F—0.1-1% by weight Wetting agent (Capstone FS-31 from Dupont or similar)

### Example #2

An inkjet receptive composition was prepared as follows:
A—30-60% 87-89% Hydrolized Polyvinyl Alcohol like Celvol 523, 540 from SekiSui or Mowiol 18-88, 56-88 from Kuraray
B—30-60% film-forming polymeric binder such as Cationic Polyurethane Dispersion (Witcobond 213, 214 PUD or similar)
C—10-30% Cationic or non-ionic filler dispersion (Raycal-29033 from Specialty Polymer Products or similar)
D—0.1-1% Wetting agent (Capstone FS-31 from Dupont or similar)

### Example #3

An inkjet receptive composition was prepared as follows:
A—10-25% crosslinked PVP (ViviPrint 540, Viviprint 200, Viviprint PS-10 from Ashland Specialty Chemicals or similar)
B—10-25% 87-89% Hydrolized Polyvinyl Alcohol like Celvol 523, 540 from SekiSui or Mowiol 18-88, 56-88 from Kuraray
C—10-25% film-forming polymeric binder such as Cationic Polyurethane Dispersion (Witcobond213, 214 PUD or similar)
D—0.1-1% Wetting agent (Capstone FS-31 from Dupont or similar)

Inkjet Receptive Coating Compositions for Ulano Diffraction Reducing Yellow.

The examples above can be further modified to create fulfill inventive yellow inkjet receptive layer, if one of the below or combination of the below is added to any of the examples above:
A—0.01-3.0% by weight of yellow dye, such as Yellow Dye #5 from Sensient or similar
B—0.01-10% by weight of yellow pigment water-based dispersion, such as Sunsperse YPD-9773 or similar

Similar light absorbing/anti-halation properties can be created, if the yellow and or black colorants is used in combination with other colors.

While the invention has been described in detail and with reference to specific examples thereof, it will be apparent to one skilled in the art that various changes and modifications can be made therein without departing from the spirit and scope thereof.

What is claimed is:

1. A light transmissive film having an ink receptive coating comprising:
a support layer, wherein the support layer is coated with an ink receiving layer, wherein said ink receiving layer comprises:
at least one diffraction reducing agent present at a concentration of about 0.001%-3.0%;
at least one absorbing polymer present at a concentration of about 0.10-50% by weight;
at least one film-forming polymeric binder present at a concentration of about 0-30% by weight;
at least one film-forming polymeric secondary binder present at a concentration of about 0-30% by weight;
at least one filler dispersion present at a concentration of about 0.10-25% by weight;
at least one coagulating agent present at a concentration of about 0.2-15% by weight;
at least one wetting agent present at a concentration of about 0.1-1% by weight.

2. The light transmissive film of claim 1 wherein the support layer is selected from the group consisting of polyolefin, polyester, polyamide, acrylic, polyurethane, polyethylene, polypropylene, polystyrene, polyethylene terephthalate, polyethylene naphthalate, triacetylcellulose, polyvinyl chloride, polyvinylidene chloride, polyimide, polycarbonate, cellophane, polynylon, and combinations thereof.

3. The light transmissive film of claim 1 wherein the at least one diffraction reducing agent is selected from the group consisting of Yellow Dye #5, Tartrazine, Pigment Yellow 14, Pigment Yellow 83, Pigment Yellow 155, Pigment Yellow 74, and combinations thereof.

4. The light transmissive film of claim 1 wherein the at least one absorbing polymer is selected from the group consisting of polyvinylpyrrolidone, cross-linked PVP, polyvinyl-alcohol, modified celluloses, methylcellulose, hydroxypropylmethylcellulose and hydroxyethyl-methylcellulose, ethylcellulose, ethylhydroxyethyl cellulose and hydroxybutyl cellulose, polyacrylamides, modified polyvinyl pyrrolidones, polyvinyl alcohol, modified polyvinyl alcohols methacrylamide; alkyltertiaryaminoalkylacryates and methacrylates; vinylpyridines such as 2-vinyl and 4-vinyl pyridines; preferably N-vinyl-2-pyrrolidone; acrylamide, methacrylamide and their N-monoalkyl and N,N-dialkyl derivatives thereof; hydroxyalkyl acrylate, methacrylate, and combinations thereof.

5. The light transmissive film of claim 1 wherein the at least one film-forming polymeric binder is selected from the group consisting of acrylic, cationic polymer dispersions, a cationic styrene-acrylic latex polymer, vinyl chloride-vinyl acetate copolymers, vinyl chloride-vinyl acetate-vinyl alcohol copolymers, vinyl chloride-vinyl acetate-maleic acid polymers, vinyl chloride-vinylidene chloride copolymers, vinyl chloride-acrylonitrile copolymers, acrylic ester-acrylonitrile copolymers, acrylic estervinylidene chloride copolymers, methacrylic estervinylidene chloride copolymers, methacrylic esterstylene copolymers, thermoplastic polyurethane resins, phenoxy resins, polyvinyl alcohol, polyvinyl fluoride, vinylidene, chloride-acrylonitrile copolymers, butadieneacrylonitrile copolymers, acrylonitrile-butadieneacrylic acid copolymers, acrylonitrile-butadienemethacrylic acid copolymers, polyvinyl butyral, polyvinyl acetal, cellulose derivatives, styrenebutadiene copolymers, polyester resins, phenolic resins, epoxy resins, thermosetting polyurethane resins, urea resins, melamine resins, alkyl resins, urea-formaldehyde resins, cellulose acetate, cellulose diacetate, cellulose triacetate, cellulose acetate butyrate, cellulose acetate propionate, and combinations thereof.

6. The light transmissive film of claim 1 wherein the at least one film-forming polymeric secondary binder is selected from the group consisting of acrylic, cationic polymer dispersions, a cationic styrene-acrylic latex polymer, vinyl chloride-vinyl acetate copolymers, vinyl chloride-vinyl acetate-vinyl alcohol copolymers, vinyl chloride-vinyl acetate-maleic acid polymers, vinyl chloride-vinylidene chloride copolymers, vinyl chloride-acrylonitrile copolymers, acrylic ester-acrylonitrile copolymers, acrylic estervinylidene chloride copolymers, methacrylic estervinylidene chloride copolymers, methacrylic esterstylene copolymers, thermoplastic polyurethane resins, phenoxy resins, polyvinyl alcohol, polyvinyl fluoride, vinylidene, chloride-acrylonitrile copolymers, butadieneacrylonitrile copolymers, acrylonitrile-butadieneacrylic acid copolymers, acrylonitrile-butadienemethacrylic acid copolymers, polyvinyl butyral, polyvinyl acetal, cellulose derivatives, styrenebutadiene copolymers, polyester resins, phenolic resins, epoxy resins, thermosetting polyurethane resins, urea resins, melamine resins, alkyl resins, urea-formaldehyde resins, cellulose acetate, cellulose diacetate, cellulose triacetate, cellulose acetate butyrate, cellulose acetate propionate, and combinations thereof.

7. The light transmissive film of claim 1 wherein the at least one filler dispersion is selected from the group consisting of Silica, colloidal silica, alumina or alumina hydrate, colloidal alumina, a surface-processed cation colloidal silica, aluminum silicate, magnesium silicate, magnesium carbonate, titanium dioxide, zinc oxide, calcium carbonate, kaoline, talc, clay, calcium sulfate, barrium sulfate, zinc sulfate, zinc carbonate, satin white, diatomaceous earth, synthetic amorphous silica, aluminum hydroxide, lithopone, zeolite, magnesium hydroxide, synthetic mica, polystyrene, polymethacrylate, polymethyl-methacrylate, elastomers, ethylene-vinyl acetate copolymers, polyesters, polyester-copolymers, polyacrylates, polyvinylethers, polyamides, polyolefines, polysilicones, guanamine resins, polytetrafluoroethylene, elastomeric styrene-butadiene rubber (SBR), elastomeric butadiene-acrylonitrile rubber (NBR), urea resins, urea-formalin resins, and combinations thereof.

8. The light transmissive film of claim 1 wherein the at least one coagulating agent is polymerized diallyldimethylammonium chloride (polyDADMAC).

9. The light transmissive film of claim 1 wherein the at least one wetting agent is selected from the group consisting of ethoxylated surfactants, polytetrafluoroalkylene surfactants, ethoxylated surfactants, Polytetrafluoroalkylene surfactants, polyethylene oxide-b-poly(tetrafluoroethylene)polymers, 2-(perfluoroalkyl)ethyl stearate, anionic lithium carboxylate fluorosurfactant, anionic phosphate fluorosurfactant, anionic phosphate surfactant, amphoteric quaternary ammonium-acetate fluorosurfactant, fluoroaliphatic polymeric esters, their derivatives, ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether, and combinations thereof.

10. A method of making a light transmissive film having an ink receptive coating, the method comprising the steps of:
providing a support layer,
coating the support layer with an ink receiving layer, wherein said ink receiving layer comprises:
at least one diffraction reducing agent present at a concentration of about 0.001%-3.0%;
at least one absorbing polymer present at a concentration of about 0.10-50% by weight;
at least one film-forming polymeric binder present at a concentration of about 0-30% by weight;
at least one film-forming polymeric secondary binder present at a concentration of about 0-30% by weight;
at least one filler dispersion present at a concentration of about 0.10-25% by weight;
at least one coagulating agent present at a concentration of about 0.2-15% by weight;
at least one wetting agent present at a concentration of about 0.1-1% by weight, thereby making a light transmissive film.

11. A method of making a mask screen printing positive, the method comprising the steps of:
i)—providing a light transmissive film having an ink receptive coating comprising:
a support layer, wherein the support layer is coated with an ink receiving layer, wherein said ink receiving layer comprises:
at least one diffraction reducing agent present at a concentration of about 0.001%-3.0%;
at least one absorbing polymer present at a concentration of about 0.10-50% by weight;
at least one film-forming polymeric binder present at a concentration of about 0-30% by weight;
at least one film-forming polymeric secondary binder present at a concentration of about 0-30% by weight;
at least one filler dispersion present at a concentration of about 0.10-25% by weight;
at least one coagulating agent present at a concentration of about 0.2-15% by weight;
at least one wetting agent present at a concentration of about 0.1-1% by weight,
ii) applying an image to the light transmissive film.

12. A method of screen printing, the method comprising the steps of:
i)—providing a light transmissive film having an ink receptive coating comprising:
a support layer, wherein the support layer is coated with an ink receiving layer, wherein said ink receiving layer comprises:
at least one diffraction reducing agent present at a concentration of about 0.001%-3.0%;
at least one absorbing polymer present at a concentration of about 0.10-50% by weight;
at least one film-forming polymeric binder present at a concentration of about 0-30% by weight;
at least one film-forming polymeric secondary binder present at a concentration of about 0-30% by weight;
at least one filler dispersion present at a concentration of about 0.10-25% by weight;
at least one coagulating agent present at a concentration of about 0.2-15% by weight;
at least one wetting agent present at a concentration of about 0.1-1% by weight,
ii) applying an image to the light transmissive film, thereby forming a mask,
iii) applying the mask to a light-sensitive material,
iv) exposing the mask and light sensitive material to a radiation source, forming a film master image,
v) removing the mask,
vi) removing the uncured light sensitive material,
thereby forming a stencil.

13. A light transmissive film having an ink receptive coating comprising:
a support layer, wherein the support layer is coated with an ink receiving layer, wherein said ink receiving layer comprises:
at least one diffraction reducing agent present at a concentration of about 0.001%-3.0%;
at least one polyvinyl alcohol present at a concentration of about 30-60% by weight;
at least one film forming polymeric binder present at a concentration of about 30-60% by weight;
at least one filler dispersion present at a concentration of about 10-30% by weight;
at least one wetting agent present at a concentration of about 0.1-1% by weight.

14. The light transmissive film of claim 13 wherein the at least one film-forming polymeric binder is selected from the group consisting of binder is selected from the group consisting of acrylic, cationic polymer dispersions, a cationic styrene-acrylic latex polymer, vinyl chloride-vinyl acetate copolymers, vinyl chloride-vinyl acetate-vinyl alcohol copolymers, vinyl chloride-vinyl acetate-maleic acid polymers, vinyl chloride-vinylidene chloride copolymers, vinyl chloride-acrylonitrile copolymers, acrylic ester-acrylonitrile copolymers, acrylic estervinylidene chloride copolymers, methacrylic estervinylidene chloride copolymers, methacrylic esterstylene copolymers, thermoplastic polyurethane resins, phenoxy resins, polyvinyl alcohol, polyvinyl fluoride, vinylidene, chloride-acrylonitrile copolymers, butadieneacrylonitrile copolymers, acrylonitrile-butadieneacrylic acid copolymers, acrylonitrile-butadienemethacrylic acid copolymers, polyvinyl butyral, polyvinyl acetal, cellulose derivatives, styrenebutadiene copolymers, polyester resins, phenolic resins, epoxy resins, thermosetting polyurethane resins, urea resins, melamine resins, alkyl resins, urea-formaldehyde resins, cellulose acetate, cellulose diacetate, cellulose triacetate, cellulose acetate butyrate, cellulose acetate propionate, and combinations thereof, and combinations thereof.

15. The light transmissive film of claim 13 wherein the support layer is selected from the group consisting of polyolefin, polyester, polyamide, acrylic, polyurethane, polyethylene, polypropylene, polystyrene, polyethylene terephthalate, polyethylene naphthalate, triacetylcellulose, polyvinyl chloride, polyvinylidene chloride, polyimide, polycarbonate, cellophane, polynylon, and combinations thereof.

16. The light transmissive film of claim 13 wherein the at least one diffraction reducing agent is selected from the group consisting of Yellow Dye #5, Tartrazine, Pigment Yellow 14, Pigment Yellow 83, Pigment Yellow 155, Pigment Yellow 74, and combinations thereof.

17. The light transmissive film of claim 13 wherein the at least one filler dispersion is selected from the group consisting of styrene acrylic emulsion polymer, styrene, acrylic, styrene/acrylics, vinyl/acetate, poly acrylics, methacrylates or combinations thereof, and combinations thereof.

18. The light transmissive film of claim 13 wherein the at least one wetting agent is selected from the group consisting of ethoxylated surfactants, polytetrafluoroalkylene surfactants, ethoxylated surfactants, Polytetrafluoroalkylene surfactants, polyethylene oxide-b-poly(tetrafluoroethylene)polymers, 2-(perfluoroalkyl)ethyl stearate, anionic lithium carboxylate fluorosurfactant, anionic phosphate fluorosurfactant, anionic phosphate surfactant, amphoteric quaternary ammonium-acetate fluorosurfactant, fluoroaliphatic polymeric esters, their derivatives, ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether, and combinations thereof.

19. A method of making a light transmissive film having an ink receptive coating, the method comprising the steps of:
providing a support layer,
coating the support layer with an ink receiving layer, wherein said ink receiving layer comprises:
at least one diffraction reducing agent present at a concentration of about 0.001%-3.0%;
at least one polyvinyl alcohol present at a concentration of about 30-60% by weight;
at least one film forming polymeric binder present at a concentration of about 30-60% by weight;
at least one filler dispersion present at a concentration of about 10-30% by weight;
at least one wetting agent present at a concentration of about 0.1-1% by weight, thereby making a light transmissive film.

20. A method of making a mask screen printing positive, the method comprising the steps of:
i)—providing a light transmissive film having an ink receptive coating comprising:
a support layer, wherein the support layer is coated with an ink receiving layer, wherein said ink receiving layer comprises:
at least one diffraction reducing agent present at a concentration of about 0.001%-3.0%;
at least one polyvinyl alcohol present at a concentration of about 30-60% by weight;
at least one film forming polymeric binder present at a concentration of about 30-60% by weight;
at least one filler dispersion present at a concentration of about 10-30% by weight;
at least one wetting agent present at a concentration of about 0.1-1% by weight
ii) applying an image to the light transmissive film.

21. A method of screen printing, the method comprising the steps of:
i)—providing a light transmissive film having an ink receptive coating comprising:
a support layer, wherein the support layer is coated with an ink receiving layer, wherein said ink receiving layer comprises:
at least one diffraction reducing agent present at a concentration of about 0.001%-3.0%;
at least one polyvinyl alcohol present at a concentration of about 30-60% by weight;
at least one film forming polymeric binder present at a concentration of about 30-60% by weight;
at least one filler dispersion present at a concentration of about 10-30% by weight;
at least one wetting agent present at a concentration of about 0.1-1% by weight
ii) applying an image to the light transmissive film, thereby forming a mask,
iii) applying the mask to a light-sensitive material,
iv) exposing the mask and light sensitive material to a radiation source, forming a film master image,
v) removing the mask,
vi) removing the uncured light sensitive material,
thereby forming a stencil.

22. A light transmissive film having an ink receptive coating comprising:
a support layer, wherein the support layer is coated with an ink receiving layer, wherein said ink receiving layer comprises:
at least one diffraction reducing agent present at a concentration of about 0.001%-3.0%;
at least one crosslinked polyvinylpyrrolidone (PVP) present at a concentration of about 10-25%;
at least one polyvinyl alcohol present at a concentration of about 10-255% by weight;
at least one film forming polymeric binder present at a concentration of about 0-30% by weight;
at least one wetting agent present at a concentration of about 0.1-1% by weight.

23. The light transmissive film of claim 22 wherein the support layer is selected from the group consisting of polyolefin, polyester, polyamide, acrylic, polyurethane, polyethylene, polypropylene, polystyrene, polyethylene terephthalate, polyethylene naphthalate, triacetylcellulose, polyvinyl chloride, polyvinylidene chloride, polyimide, polycarbonate, cellophane, polynylon, and combinations thereof.

24. The light transmissive film of claim 22 wherein the at least one diffraction reducing agent is selected from the group consisting of Yellow Dye #5, Tartrazine, Pigment Yellow 14, Pigment Yellow 83, Pigment Yellow 155, Pigment Yellow 74, and combinations thereof.

25. The light transmissive film of claim 22 wherein the at least one film-forming polymeric binder is selected from the group consisting of acrylic, cationic polymer dispersions, a cationic styrene-acrylic latex polymer, vinyl chloride-vinyl acetate copolymers, vinyl chloride-vinyl acetate-vinyl alcohol copolymers, vinyl chloride-vinyl acetate-maleic acid polymers, vinyl chloride-vinylidene chloride copolymers, vinyl chloride-acrylonitrile copolymers, acrylic ester-acrylonitrile copolymers, acrylic estervinylidene chloride copolymers, methacrylic estervinylidene chloride copolymers, methacrylic esterstylene copolymers, thermoplastic polyurethane resins, phenoxy resins, polyvinyl alcohol, polyvinyl fluoride, vinylidene, chloride-acrylonitrile copolymers, butadieneacrylonitrile copolymers, acrylonitrile-butadieneacrylic acid copolymers, acrylonitrile-butadienemethacrylic acid copolymers, polyvinyl butyral, polyvinyl acetal, cellulose derivatives, styrenebutadiene copolymers, polyester resins, phenolic resins, epoxy resins, thermosetting polyurethane resins, urea resins, melamine resins, alkyl resins, urea-formaldehyde resins, cellulose acetate, cellulose diacetate, cellulose triacetate, cellulose acetate butyrate, cellulose acetate propionate, and combinations thereof.

26. The light transmissive film of claim 22 wherein the at least one wetting agent is selected from the group consisting of ethoxylated surfactants, polytetrafluoroalkylene surfactants, ethoxylated surfactants, Polytetrafluoroalkylene surfactants, polyethylene oxide-b-poly(tetrafluoroethylene)polymers, 2-(perfluoroalkyl)ethyl stearate, anionic lithium carboxylate fluorosurfactant, anionic phosphate fluorosurfactant, anionic phosphate surfactant, amphoteric quaternary ammonium-acetate fluorosurfactant, fluoroaliphatic polymeric esters, their derivatives, ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-iso-propyl ether, and combinations thereof.

27. A method of making a light transmissive film having an ink receptive coating, the steps comprising:
providing a support layer,
coating the support layer with an ink receiving layer, wherein said ink receiving layer comprises:
at least one diffraction reducing agent present at a concentration of about 0.001%-3.0%;
at least one crosslinked polyvinylpyrrolidone (PVP) present at a concentration of about 10-25%;
at least one polyvinyl alcohol present at a concentration of about 10-255% by weight;
at least one film forming polymeric binder present at a concentration of about 0-30% by weight;
at least one wetting agent present at a concentration of about 0.1-1% by weight, thereby making a light transmissive film.

28. A method of making a mask screen printing positive, the method comprising the steps of:
i)—providing a light transmissive film having an ink receptive coating comprising:
a support layer, wherein the support layer is coated with an ink receiving layer, wherein said ink receiving layer comprises:
at least one diffraction reducing agent present at a concentration of about 0.001%-3.0%;
at least one crosslinked polyvinylpyrrolidone (PVP) present at a concentration of about 10-25%;
at least one polyvinyl alcohol present at a concentration of about 10-255% by weight;
at least one film forming polymeric binder present at a concentration of about 0-30% by weight;
at least one wetting agent present at a concentration of about 0.1-1% by weight
ii) applying an image to the light transmissive film.

29. A method of screen printing, the method comprising the steps of:
i)—providing a light transmissive film having an ink receptive coating comprising:
a support layer, wherein the support layer is coated with an ink receiving layer, wherein said ink receiving layer comprises:
at least one diffraction reducing agent present at a concentration of about 0.001%-3.0%;
at least one crosslinked polyvinylpyrrolidone (PVP) present at a concentration of about 10-25%;
at least one polyvinyl alcohol present at a concentration of about 10-255% by weight;
at least one film forming polymeric binder present at a concentration of about 0-30% by weight;
at least one wetting agent present at a concentration of about 0.1-1% by weight
ii) applying an image to the light transmissive film, thereby forming a mask,
iii) applying the mask to a light-sensitive material,
iv) exposing the mask and light sensitive material to a radiation source, forming a film master image,
v) removing the mask,
vi) removing the uncured light sensitive material,
thereby forming a stencil.
